(19) United States
(12) Patent Application Publication
(10) Pub. No.: US 2026/0050842 A1
(43) Pub. Date: Feb. 19, 2026

(54) DATA GENERATION AND RETRAINING TECHNIQUES FOR FINE-TUNING OF BI-ENCODING AND CROSS-ENCODING MODELS FOR EFFICIENT DATA RETRIEVAL

(71) Applicant: Goldman Sachs & Co. LLC, New York, NY (US)

(72) Inventors: Eliot P. Brenner, Westfield, NJ (US); Koustuv Dasgupta, Scarsdale, NY (US); Dominic Seyler, Jersey City, NJ (US)

(21) Appl. No.: 19/300,456

(22) Filed: Aug. 14, 2025

Related U.S. Application Data
(60) Provisional application No. 63/684,211, filed on Aug. 16, 2024.

(51) Int. Cl. G06N 20/20; G06F 16/2457

(52) U.S. Cl. CPC G06N 20/20; G06F 16/24575

(57) ABSTRACT

A method includes obtaining a raw text corpus and a set of seed queries. The method also includes training a retrieval pipeline having a bi-encoding model and a cross-encoding model using the raw text corpus and the set of seed queries. The method further includes outputting a trained bi-encoding model and a trained cross-encoding model. Training the retrieval pipeline includes (i) training the bi-encoding model to perform initial embedding-based retrieval of segments from the raw text corpus and (ii) training the cross-encoding model to perform re-ranking or refinement of the retrieved segments.

### CROSS-REFERENCE TO RELATED APPLICATION AND PRIORITY CLAIM

This application claims priority under 35 U.S.C. § 119(e) to U.S. Provisional Patent Application No. 63/684,211 filed on Aug. 16, 2024, which is hereby incorporated by reference in its entirety.

### TECHNICAL FIELD

This disclosure is generally directed to machine learning systems and processes. More specifically, this disclosure is directed to data generation and retraining techniques for fine-tuning of bi-encoding and cross-encoding models for efficient data retrieval.

### BACKGROUND

Large language models (LLMs) represent neural networks or other machine learning models that include many parameters (often billions of parameters) and that are trained on large quantities of unlabeled text using self-supervised learning. Many large language models use a transformer-based machine learning architecture and are pre-trained in a generative manner. Large language models can find use in a number of natural language processing (NLP) tasks or other tasks, such as when large language models are used to process input queries from users and generate natural language responses to the input queries.

### SUMMARY

This disclosure relates to data generation and retraining techniques for fine-tuning of bi-encoding and cross-encoding models for efficient data retrieval.

In a first embodiment, a method includes obtaining a raw text corpus and a set of seed queries. The method also includes training a retrieval pipeline having a bi-encoding model and a cross-encoding model using the raw text corpus and the set of seed queries. The method further includes outputting a trained bi-encoding model and a trained cross-encoding model. Training the retrieval pipeline includes (i) training the bi-encoding model to perform initial embedding-based retrieval of segments from the raw text corpus and (ii) training the cross-encoding model to perform re-ranking or refinement of the retrieved segments.

Any single one or any combination of the following additional features may be used with the first embodiment.

Training the retrieval pipeline may include identifying and outputting one or more evaluation metrics comparing the trained retrieval pipeline and an untrained retrieval pipeline.

Training the retrieval pipeline may include providing the set of seed queries to at least one large language model and receiving additional queries from the at least one large language model.

The method may include obtaining an input query at a retriever model. The retriever model may include the trained bi-encoding model and the trained cross-encoding model. The retriever model may be configured to identify specified chunks of information relevant to the input query. The method may also include providing one or more of the specified chunks of information from the retriever model to a generative model and using the generative model to create a response to the input query. The response may be based on the one or more specified chunks of information.

The method may include using the raw text corpus and the set of seed queries to generate positive and negative training examples for the bi-encoding model and the cross-encoding model. The positive and negative training examples for the bi-encoding model may include triples having a form (query, more relevant document/chunk, less relevant document/chunk). The positive and negative training examples for the cross-encoding model may include triples having a form (query, passage/chunk, score).

The method may include performing an evaluation of the trained bi-encoding model and the trained cross-encoding model. The evaluation may include performing bi-clustering to generate clusters of data related to the corpus, determining a probability distribution based on one or more metrics associated with the clusters, and sampling data from a testing corpus based on the probability distribution.

In a second embodiment, a method includes generating training samples for a retriever model using chunks of information, where the retriever model includes a cross-encoding model. The method also includes training the retriever model using the training samples, where the cross-encoding model is trained to rank chunks of information that are relevant to input queries. Generating the training samples includes using at least one large language model to generate the training samples.

Any single one or any combination of the following additional features may be used with the second embodiment.

Using the at least one large language model to generate the training samples may include providing example input queries to the at least one large language model and generating additional input queries using the at least one large language model. The training samples may be based on the input queries and the additional input queries.

Generating the additional input queries may include converting the example input queries into dense vector representations and clustering the dense vector representations into multiple clusters. Generating the additional input queries may also include randomly selecting a subset of the clusters and randomly selecting an example input query from each of the selected clusters. Generating the additional input queries may further include using a template to create a prompt from the selected example input queries and providing the prompt to the at least one large language model to generate one or more additional synthetic input queries.

Using the at least one large language model to generate the training samples may include (i) using a bi-encoding model to identify subsets of the chunks of information that might be or might not be relevant to the input queries and (ii) using the at least one large language model to determine whether the subsets of the chunks of information actually are or are not relevant to the input queries.

Using the bi-encoding model to identify the subsets of the chunks of information that might be or might not be relevant to the input queries may include identifying positive and negative training examples using the bi-encoding model. The positive training examples may represent chunks of information that might be relevant to the input queries. The negative training examples may represent chunks of information that might not be relevant to the input queries. One or more of the positive training examples and one or more of the negative training examples may be obtained from a common document.

The at least one large language model may rank the positive training examples and the negative training examples, and the at least one large language model may rank the positive training examples as being more relevant to the input queries and ranking the negative training examples as being less relevant or irrelevant to the input queries. The cross-encoding model and the bi-encoding model may rank the positive training examples and the negative training examples, and the cross-encoding model and the bi-encoding model may rank the negative training examples higher than the positive training examples.

Using the at least one large language model to determine whether the subsets of the chunks of information actually are or are not relevant to the input queries may include using the at least one large language model to judge the positive and negative training examples and determine which of the positive and negative training examples to include in the training samples.

A first large language model may process pairs of chunks of information to determine which of the chunks of information is more or less relevant to the input queries. A second large language model may process candidate chunks of information selected by the first large language model to generate the training samples.

Using the at least one large language model to generate the training samples may include (i) using a bi-encoding/cross-encoding pipeline to identify subsets of the chunks of information that might or might not be relevant to the input queries and (ii) using the large language model to determine a degree of relevance of the subsets of the chunks of information to the input queries.

The retriever model may include a bi-encoding model. The bi-encoding model may be trained to identify subsets of the chunks of information that might be relevant to the input queries. The cross-encoding model may be trained to rank the chunks of information within each subset that are relevant to input queries.

The retriever model may be configured to provide relevant chunks of information to a generative model.

The method may include obtaining an input query at the retriever model, and the retriever model may include the trained cross-encoding model. The retriever model may be configured to identify specified chunks of information relevant to the input query. The method may also include providing one or more of the specified chunks of information from the retriever model to a generative model. The method may further include using the generative model to create a response to the input query. The response may be based on the one or more specified chunks of information.

The method may include using the chunks of information and a set of seed queries to generate positive and negative training examples for a bi-encoding model and the cross-encoding model. The positive and negative training examples for the bi-encoding model may include triples having a form (query, more relevant document/chunk, less relevant document/chunk). The positive and negative training examples for the cross-encoding model may include triples having a form (query, passage/chunk, score).

The method may include performing an evaluation of the trained retriever model. The evaluation may include performing bi-clustering to generate clusters of data related to a corpus, determining a probability distribution based on one or more metrics associated with the clusters, and sampling data from a testing corpus based on the probability distribution.

In other embodiments, an apparatus may include at least one processing device configured to perform the method of the first embodiment (optionally along with any single one or any combination of the additional features described above related to the first embodiment) and/or perform the method of the second embodiment (optionally along with any single one or any combination of the additional features described above related to the second embodiment).

In still other embodiments, a non-transitory computer readable medium contains instructions that when executed cause at least one processor to perform the method of the first embodiment (optionally along with any single one or any combination of the additional features described above related to the first embodiment) and/or perform the method of the second embodiment (optionally along with any single one or any combination of the additional features described above related to the second embodiment).

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting data generation and retraining techniques for fine-tuning of bi-encoding and cross-encoding models for efficient data retrieval according to this disclosure;

FIG. 2 illustrates an example device supporting data generation and retraining techniques for fine-tuning of bi-encoding and cross-encoding models for efficient data retrieval according to this disclosure;

FIGS. 3A and 3B illustrate an example sentence transformer for use in a retriever model according to this disclosure;

FIGS. 4 and 5 illustrate an example implementation of a chunk-based dataset generation according to this disclosure;

FIG. 6 illustrates an example implementation of a query-based dataset generation according to this disclosure;

FIG. 7 illustrates an example implementation of a query-centric technique to evaluate the performance of a trained embedding model according to this disclosure;

FIG. 8 illustrates an example implementation of a model-centric technique to evaluate the performance of a trained embedding model according to this disclosure;

FIG. 9 illustrates an example method for data generation and retraining techniques for fine-tuning of embedding models for efficient data retrieval according to this disclosure;

FIG. 10 illustrates an example method for using fine-tuned embedding models for efficient data retrieval according to this disclosure;

FIG. 11 illustrates an example retriever model containing bi-encoding and cross-encoding models for efficient data retrieval according to this disclosure;

FIG. 12 illustrates an example implementation of synthetic query generation for use in producing a query-based training dataset according to this disclosure;

FIG. 13 illustrates an example implementation of a query-based dataset generation according to this disclosure;

FIG. 14 illustrates an example implementation of a technique to evaluate the performance of a trained retriever model containing bi-encoding and cross-encoding models according to this disclosure;

FIG. 15 illustrates an example method for data generation and retraining techniques for fine-tuning of retriever models containing bi-encoding and cross-encoding models according to this disclosure;

FIG. 16 illustrates an example method for using fine-tuned retriever models containing bi-encoding and cross-encoding models according to this disclosure; and

FIGS. 17 and 18 illustrate a specific example of methods for fine-tuning of retriever models containing bi-encoding and cross-encoding models according to this disclosure.

### DETAILED DESCRIPTION

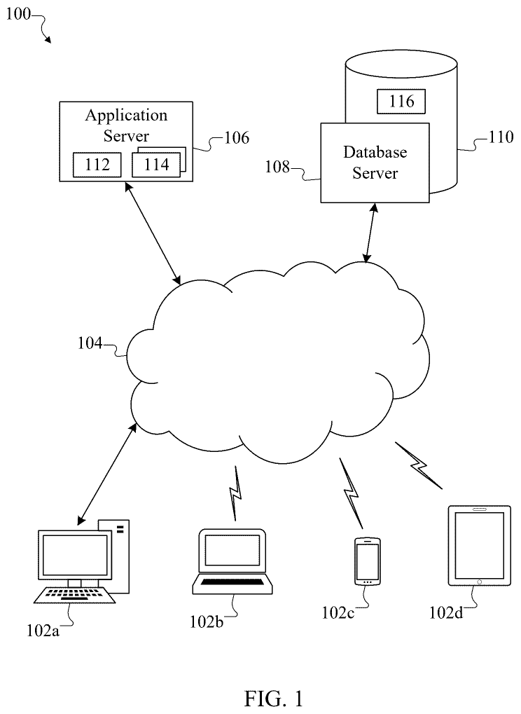

FIGS. 1 through 18, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

As noted above, large language models (LLMs) represent neural networks or other machine learning models that include many parameters (often billions of parameters) and that are trained on large quantities of unlabeled text using self-supervised learning. Many large language models use a transformer-based machine learning architecture and are pre-trained in a generative manner. Large language models can find use in a number of natural language processing (NLP) tasks or other tasks, such as when large language models are used to process input queries from users and generate natural language responses to the input queries.

Unfortunately, applying large language models to real-world mission-critical applications remains challenging. Among other reasons, this can be due to the tendency of large language models to be trained for general-purpose usage. This makes it difficult to apply the large language models to specialized domains, such as specialized fields like manufacturing, finance, and healthcare. Stated another way, large languages models have opened new horizons for professionals in numerous industries to interact with their data and knowledge stores in a much more natural way, such as via synchronous chat or via pre-set “questionnaires” asynchronously. However, these generative models typically have some limitations in that they are trained on general-purpose historical corpora. Consequently, these models often cannot answer questions requiring domain-specific or up-to-date information.

One technique for addressing these deficiencies is using a retrieval engine to search a domain-specific corpus for relevant documents or chunks to include in a prompt for a large language model. In these situations, these chunks are commonly referred to as “context” for the large language model. Although it might be more precise to refer to the entire prompt incorporating the chunks as the large language model's context, this terminology is adopted in this patent document. The entire system here may be referred to as a “retrieve-then-read pipeline,” where the retrieval engine obtains relevant chunks and the large language model reads and processes those relevant chunks. Naturally, the success of the retrieve-then-read pipeline in practice can depend to a significant extent on the quality of the retrieved chunks, which may be rephrased in information retrieval (IR) terms as the relevance of the retrieved chunks to a query.

Experience has shown that in certain specialized domains (such as financial, healthcare, and other domains associated with specialized datasets), the performance of a retriever model used for large-scale retrieval can be a significant limiting factor on the success of a retrieve-then-read pipeline. The notion of similarity or relevance is subjective by nature and can differ greatly for specialized professional users in various domains versus ordinary general users, such as based on the use of vocabulary and other assumptions underlying the specialized domains. Open-source or general-purpose commercial (proprietary) models are often trained with information-retrieval needs of a general user in mind, not specialized professional users.

This disclosure provides techniques supporting data generation and retraining techniques for fine-tuning of bi-encoding and cross-encoding models for efficient data retrieval. As described in more detail below, a framework can include a retriever model and a generative model. In some cases, the generative model may represent a large language model. The retriever model can be used to receive and process input queries (such as from users), identify one or more relevant chunks of information associated with each input query, and provide the input queries and the relevant chunks as prompts to the generative model. The relevant chunks of information may be identified from documents, websites, or any other suitable source(s) of information. The generative model can process the relevant chunk(s) of information associated with each prompt and generate an output (such as a natural language output) for each prompt.

The retriever model can represent or include a bi-encoding model and a cross-encoding model, which can be fine-tuned using synthetic training data. For example, the bi-encoding model can be used to select a subset of relevant chunks of information from a larger corpus, and the cross-encoding model can be used to rank the relevant chunks of information in the subset and select the higher-ranked chunks of information. In some cases, the synthetic training data used to train the bi-encoding model and the cross-encoding model can be generated using at least one large language model, such as by using the at least one large language model to identify chunks of information that are treated as relevant or not relevant for training purposes. This allows the at least one large language model to be used to effectively generate annotated synthetic training data, including both positive examples (where training chunks of information are relevant to queries) and negative examples (where training chunks of information are not relevant to queries).

In this way, the described techniques may allow the retriever model (including the bi-encoding model and the cross-encoding model) to be fine-tuned (trained) more effectively to identify relevant chunks of information to be provided to the generative model, which can increase the quality of the outputs generated by the generative model. Among other things, the described techniques can address the gap in retrieve-then-read pipelines by fine-tuning custom retriever models based on in-domain datasets. One factor affecting the retriever model may be the definition of embeddings, and various motivations for some embodiments of the proposed framework described below can include (i) determining the efficacies of pre-trained (off-the-shelf) embeddings and (ii) developing novel datasets and fine-tuned custom embeddings for the datasets.

### Example Architecture

FIG. 1 illustrates an example system 100 supporting data generation and retraining techniques for fine-tuning of bi-encoding and cross-encoding models for efficient data retrieval according to this disclosure. As shown in FIG. 1, the system 100 includes multiple user devices 102a-102d, at least one network 104, at least one application server 106, and at least one database server 108 associated with at least one database 110. Note, however, that other combinations and arrangements of components may also be used here.

In this example, each user device 102a-102d is coupled to or communicates over the network(s) 104. Communications between each user device 102a-102d and at least one network 104 may occur in any suitable manner, such as via a wired or wireless connection. Each user device 102a-102d represents any suitable device or system used by at least one user to provide information to the application server 106 or database server 108 or to receive information from the application server 106 or database server 108. Any suitable number(s) and type(s) of user devices 102a-102d may be used in the system 100. In this particular example, the user device 102a represents a desktop computer, the user device 102b represents a laptop computer, the user device 102c represents a smartphone, and the user device 102d represents a tablet computer. However, any other or additional types of user devices may be used in the system 100. Each user device 102a-102d includes any suitable structure configured to transmit and/or receive information, such as devices that can transmit user input queries and that can receive and present responses to the user input queries.

The at least one network 104 facilitates communication between various components of the system 100. For example, the network(s) 104 may communicate Internet Protocol (IP) packets, frame relay frames, Asynchronous Transfer Mode (ATM) cells, or other suitable information between network addresses. The network(s) 104 may include one or more local area networks (LANs), metropolitan area networks (MANs), wide area networks (WANs), all or a portion of a global network such as the Internet, or any other communication system or systems at one or more locations. The network(s) 104 may also operate according to any appropriate communication protocol or protocols.

The application server 106 is coupled to the at least one network 104 and is coupled to or otherwise communicates with the database server 108. The application server 106 supports various functions related to data generation and retraining techniques for fine-tuning of bi-encoding and cross-encoding models. For example, the application server 106 may perform various operations using a framework that includes one or more retriever models 112 and one or more generative models 114. Each retriever model 112 is configured to receive and process input queries (such as queries from the user devices 102a-102d), identify one or more relevant chunks of information associated with each input query, and provide the input queries and the relevant chunks of information as prompts to at least one generative model 114. The relevant chunks of information may be identified from documents, websites, or any other suitable source(s) of information. In some cases, for instance, the database 110 may store various documents 116 from which the relevant chunks of information may be extracted. Each generative model 114 is configured to process the relevant chunk(s) of information associated with each prompt and generate a response (such as a natural language output) for each prompt. In some cases, at least one generative model 114 can represent at least one large language model (LLM) or other machine learning model. Each response may be provided to the corresponding user device 102a-102d that provided the associated query or to any other suitable destination(s).

Each retriever model 112 can represent a machine learning model that is fine-tuned (trained) for efficient data retrieval, such as a bi-encoding model and a cross-encoding model. For example, each retriever model 112 may be trained to generate embeddings, and each retriever model 112 can be trained/fine-tuned using synthetic training data. Various techniques provided below allow at least some of the synthetic training data to be generated using at least one generative model 114 (such as at least one large language model). Note that the generative model(s) 114 used to generate the synthetic training data may or may not represent one or more of the generative models 114 used to generate responses to input queries. The at least one generative model 114 may be used to identify chunks of information that are treated as relevant or not relevant for training purposes, such as by generating annotated synthetic training data containing both positive examples and negative examples. In this way, the described techniques may allow the retriever model(s) 112 to be trained more effectively to identify relevant chunks of information to be provided to the generative model(s) 114, which can increase the quality of the outputs generated by the generative model(s) 114.

The database server 108 operates to store and facilitate retrieval of various information used, generated, or collected by the application server 106 and the user devices 102a-102d in the database 110. For example, the database server 108 may store the various documents 116 or other information from which relevant chunks of information may be extracted by the retriever model(s) 112. While the database server 108 and database 110 are shown here as being separate from the application server 106, the application server 106 may itself incorporate the database server 108 and the database 110.

Although FIG. 1 illustrates one example of a system 100 supporting data generation and retraining techniques for fine-tuning of bi-encoding and cross-encoding models for efficient data retrieval, various changes may be made to FIG. 1. For example, the system 100 may include any number of user devices 102a-102d, networks 104, application servers 106, database servers 108, databases 110, retriever models 112, generative models 114, and documents 116. Also, these components may be located in any suitable locations and might be distributed over a large area. In addition, while FIG. 1 illustrates one example operational environment in which data generation and retraining techniques for fine-tuning of bi-encoding and cross-encoding models may be used, this functionality may be used in any other suitable system.

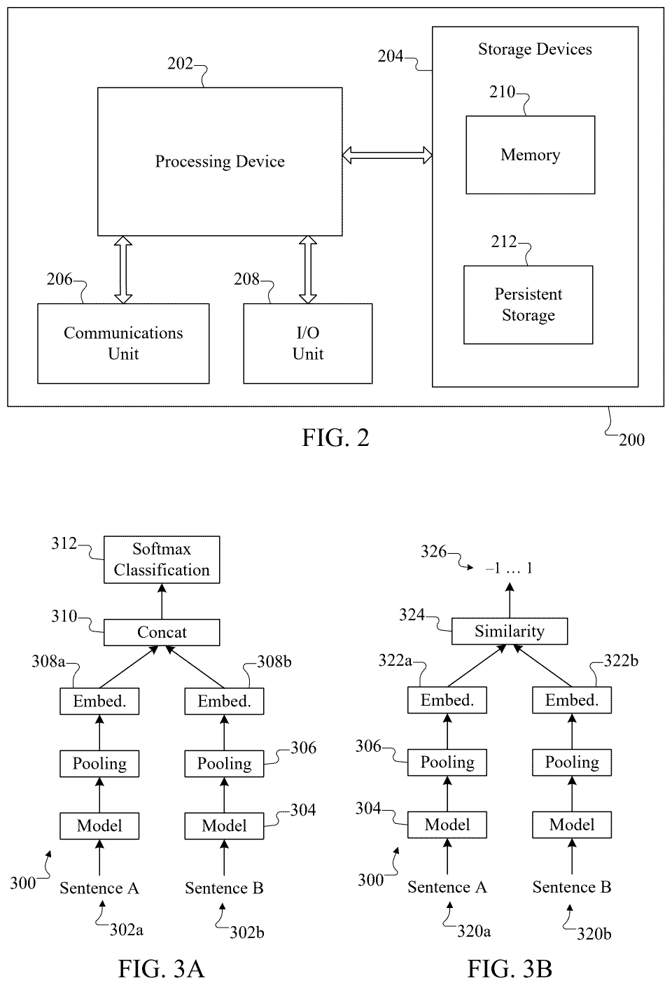

FIG. 2 illustrates an example device 200 supporting data generation and retraining techniques for fine-tuning of bi-encoding and cross-encoding models for efficient data retrieval according to this disclosure. One or more instances of the device 200 may, for example, be used to at least partially implement the functionality of the application server 106 of FIG. 1. However, the functionality of the application server 106 may be implemented in any other suitable manner. In some embodiments, the device 200 shown in FIG. 2 may form at least part of a user device 102a-102d, application server 106, or database server 108 in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), neural processing units (NPUs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network. The communications unit 206 may support communications through any suitable physical or wireless communication link(s). As a particular example, the communications unit 206 may support communication over the network(s) 104 of FIG. 1.

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. Note, however, that the I/O unit 208 may be omitted if the device 200 does not require local I/O, such as when the device 200 represents a server or other device that can be accessed remotely.

In some embodiments, the instructions executed by the processing device 202 include instructions that implement or support the use of the retriever model(s) 112 and the generative model(s) 114. Thus, for example, the instructions executed by the processing device 202 may cause the device 200 to obtain input queries, process the input queries using one or more retriever models 112, pass prompts (which may include input queries and relevant chunks of information) to one or more generative models 114, and process the relevant chunks of information using the one or more generative models 114 to generate outputs for users that are responsive to the input queries. The instructions executed by the processing device 202 may also or alternatively cause the device 200 to use at least one large language model or other generative model(s) 114 to generate synthetic training data for training one or more retriever models 112, including a bi-encoding model and a cross-encoding model.

Although FIG. 2 illustrates one example of a device 200 supporting data generation and retraining techniques for fine-tuning of bi-encoding and cross-encoding models for efficient data retrieval, various changes may be made to FIG. 2. For example, computing and communication devices and systems come in a wide variety of configurations, and FIG. 2 does not limit this disclosure to any particular computing or communication device or system.

### Example Retriever Models

The following provides additional details regarding example designs of a retriever model 112. Note that these details are for illustration and explanation only and that other implementations are possible and within the scope of this disclosure. For example, while a specific type of retriever model 112 is described below, this type of model is an example only, and retriever models 112 may be implemented using any other suitable machine learning model architecture.

One paradigm of information retrieval is to map, via an embedding model Φ (a retriever model 112), both queries Q and chunks of information C to a finite-dimensional vector space V. In some cases, the embedding model Φ can be defined as follows.

$$Φ : Q \times C \to V \times V , commonly implemented with Φ := φ \times φ , \qquad ( 1 )$$

$$where φ : {( Vocab )}^{⊗ n} \to V$$

Here, the expression φ: (Vocab)^{⊗n}→V represents the embedding of text sequences into the vector space V. The similarity between a query and a chunk of information (or between different chunks of information) can be interpreted as a “distance.” Distance can be implemented in various ways, such as by using dot-product similarity or Euclidean distance (possibly after a suitable normalization). In vector space, any distance metric m (such as cosine distance or Euclidean distance) can be used to intuitively define the notion of closeness or similarity of points corresponding to texts in Q and C. As a result, given a query q∈Q, an information retrieval system can retrieve the k closest chunks of information c∈C to the query q, meaning the information retrieval system could be mathematically represented as follows.

$${M}_{q , k} = {π}_{k} ∘ {sort}_{2} ∘ ( {Id}_{2} \times m ∘ ( φ \times φ ) ) : q \times C \to {C}^{\times k} \qquad ( 2 )$$

Here, πₖ represents a projection onto the first k chunks of information corresponding to the smallest distances, sort₂ represents sorting on the second factor (c), and Id₂ maps an ordered pair (q, c) to a single element (c) by acting as the identity on the second factor of the pair. This defines the information retrieval system based on an embedding φ, a distance metric m, and a parameter k>0.

Conventionally, the notation for the information retrieval system may be modified to the following shortened form.

$$M = m ∘ φ \times φ \qquad ( 3 )$$

This notation leaves the following factors out of the explicit definition of an embedding model M because they are either left implicit or are fixed throughout development: q (variable but implicit), k (generally fixed at ten or another value), and the sorting and projection operations (both fixed and implicit). For even more concreteness, in some embodiments of the information retrieval system, the choice of the distance metric m may be defined as follows.

$$m = Euc \qquad ( 4 )$$

Here, Euc represents Euclidean distance, so the only significant difference between systems relates to their embeddings φ.

Despite several drawbacks, the paradigm above is convenient for several reasons. First, an embedding φ can be implemented as a neural network. Techniques and technologies for training neural networks are well-developed and have enormous momentum for further improvements, and the training process for neural networks can benefit from unsupervised pre-training on unlabeled corpora. Second, the computationally-intensive step of embedding a document corpus via the embedding φ can be performed “offline” or “at indexing time” (meaning asynchronously), amortizing an O(|C|)-time operation. Third, computations of m(φ(q), φ(c)) for all c∈C implied by the above specification can be significantly “pruned” to a smaller number (such as a constant of about 100 to about 1000) as long as approximate nearest neighbor techniques are acceptable (which they typically are in practice). As a consequence, a system can be scaled to indices of essentially arbitrary sizes with constant query times.

In some embodiments, each of one or more retriever models 112 may include a sentence transformer. FIGS. 3A and 3B illustrate an example sentence transformer 300 for use in a retriever model 112 according to this disclosure. More specifically, FIG. 3A illustrates example training of the sentence transformer 300, and FIG. 3B illustrates example inferencing by the trained sentence transformer 300.

As shown in FIG. 3A, the sentence transformer 300 can receive and process two sentences 302a-302b, which in some cases may represent sentences or other portions of an input query Q and a chunk of information C or sentences or other portions of two chunks of information C. Each sentence 302a-302b is processed using a language model 304, such as a Bidirectional Encoder Representations from Transformers (BERT) model. In some cases, the language models 304 can represent networks having tied weights, thereby forming a Siamese network structure. The language models 304 can generate output vectors representing the sentences 302a-302b.

Pooling layers 306 can process the output vectors representing the sentences 302a-302b, such as by performing max pooling or average pooling. This results in the generation of a sentence embedding 308a (which may be denoted u) for the sentence 302a and a sentence embedding 308b (which may be denoted v) for the sentence 302b. In some cases, the pooling layers 306 can be used to produce fixed-sized sentence embeddings 308a-308b. A concatenation function 310 can combine the sentence embeddings 308a-308b and a difference between the sentence embeddings 308a-308b, and a softmax classification function 312 can process the resulting information to generate a prediction as to how similar the sentences 302a-302b are to one another. Predictions by the softmax classification function 312 can be used to calculate a loss of the sentence transformer 300, and the sentence transformer 300 can be adjusted during training until the loss achieves a suitably-low value.

As shown in FIG. 3B, once trained, the sentence transformer 300 can receive and process additional sentences 320a-320b using the language models 304 and the pooling layers 306 to generate additional sentence embeddings 322a-322b. A similarity function 324 can be used to compare the sentence embeddings 322a-322b and generate a similarity measure 326, which represents a measure of the similarity of the additional sentences 320a-320b. In this example, the similarity measure 326 may represent a value between −1 and +1, although other ranges for the similarity measure 326 may be used in a retriever model 112. The similarity function 324 may use any suitable technique to identify the similarities of the sentence embeddings 322a-322b, such as cosine distance or Euclidean distance.

Sentence transformers represent a convenient open-source or other software framework for training specialized embeddings φ for similarity search and retrieval. This approach by sentence transformers enables embeddings φ specific to the task of similarity retrieval and specific to a domain to be trained and deployed, which is in contrast to other approaches involving retraining “general purpose” embeddings using a language model (which is vastly more computationally-expensive and may have unclear benefits) for a specific retrieval task at hand. One potentially simpler and more immediately-applicable path to retraining sentence transformer embeddings may be available, and this approach can involve the use of some “labeled” data (in some cases on the order of about one million data points) in the form of “triples.” These triples can have the form (query, more relevant document/chunk, less relevant document/chunk). This means that one challenge towards developing embedding models for retrieval is sourcing such triples in a specialized target domain. The description below provides solutions to this challenge.

Although FIGS. 3A and 3B illustrate one example of a sentence transformer for use in a retriever model 112, various changes may be made to FIGS. 3A and 3B. For example, sentence transformers may be implemented using any other suitable machine learning model architecture. Also, retriever models 112 may be implemented in any other suitable manner and do not necessarily require the use of sentence transformers.

### Example Retriever Model Training Data Generation

The following provides additional details regarding example training/fine-tuning of the retriever models 112. More specifically, the following describes how these triples or other suitable training data can be generated in order to support suitable training of one or more retriever models 112. In general, training samples for an embedding model may be generated using chunks of information, where one or more large language models are used to generate training samples in which (i) different ones of the chunks of information are relevant to different potential input queries and (ii) different ones of the chunks of information are not relevant to different potential input queries. The embedding model can be trained using the training samples and used as a retriever model 112, which allows the embedding model to be used to provide relevant chunks of information to one or more generative models 114.

In some embodiments, triples or other suitable training data can be generated based on a specific well-defined corpus and optionally a preset list of input queries. The corpus and the optional preset list of input queries can easily vary depending on the implementation and use case. In the following discussion, it may sometimes be assumed that the specific corpus is being used with a retrieve-then-read pipeline to support a question and answer (Q&A) system that provides investment analysts with a conversational experience when interacting with and extracting information from earnings call transcripts (ECTs). Of course, other use cases can easily be supported via proper selection of the corpus, and there is no requirement that the use cases relate to finance.

Let c∈C represent a generic chunk of information in a corpus, and let D represent the entire corpus both for training and evaluation. For each document d∈D, let C(d) represent the collection of all chunks of information c in that document d. Also, let C:=∪_{{d∈D}}C(d) represent the collection of all chunks of information c in the corpus, meaning in all documents d in the corpus. When it becomes necessary to refer to the document d∈D to which a specific chunk of information c∈C belongs, that document is represented by D (c). For a fixed retriever model M, let M_{q}(d)=M_{q}(C(d)) represent the chunks of information from document d in ascending order of distance (retrieval score) from a query q, and let M_{q,k}(d) (sometimes denoted M(q, k, d)) represent a slice of the first k elements (chunks of information) in this ordered list. Evaluating one or more information retrieval (IR) metrics can be associated with metrics such as discounted cumulative gain (DCG@k), ideal discounted cumulative gain (IDCG@k), normalized discounted cumulative gain (NDCG@k), and/or mean reciprocal rank (MRR@k).

In the following discussion, example development strategies used to produce training datasets may fall into two distinct categories, which are called “document-centric” (also “chunk-centric”) and “query centric.” Common to both strategies is the use of triplet loss for training, validation, and hyperparameter tuning, which in some embodiments can be implemented through code modified from sentence transformers library. One example strategy for relying on triplet loss can be to source a large, diverse, and high-quality dataset or datasets of triples. In some cases, these triples may be defined as follows.

$$DS := {⋃}_{q} {\{ DS ( q ) \}}_{q} = \{ ( q , {c}_{q , rel} , {c}_{q , irrel} ) \} = \{ ( q , {c}_{+} , {c}_{-} ) \} ) , {c}_{+} = {c}_{q , rel} \qquad ( 5 )$$

$$more relevant to q than {c}_{-} = {c}_{q , irrel}$$

Here, DS represents a dataset, c_{q,rel} and c₊ represent a relevant chunk of information for a query q, and c_{q,irrel} and c₋ represent an irrelevant chunk of information for the query q. The notation on the left is more complete since it explicitly denotes the dependency of the notion of relevance on the query q. The notation on the right is more concise and will generally be used from now on, taking for granted that a positive (relevant) document/chunk and a negative (irrelevant) document/chunk are considered relevant or irrelevant relative to a given query q.

One way of generating such a dataset of triples is from datasets of positive and negative pairs, such as in the following manner.

$${DS}_{+} = {⋃}_{q} {\{ {DS}_{+} ( q ) \}}_{q} = {⋃}_{q , d} {\{ {DS}_{+} ( q , d ) \}}_{d} where {DS}_{+} ( q , d ) := \{ ( q , {c}_{+} ) , {c}_{+} ∈ C ( d ) \} \qquad ( 6 )$$

$${DS}_{-} = {⋃}_{q} \{ {DS}_{-} ( q ) \} = {⋃}_{q , d} {\{ {DS}_{-} ( q , d ) \}}_{d} where {DS}_{-} ( q , d ) := \{ ( q , {c}_{-} ) , {c}_{-} ∈ C ( d ) \}$$

Here, DS₊ represents a dataset of positive pairs, where each pair includes a query q and a document d or chunk of information c relevant to that query q. Similarly, DS₋ represents a dataset of negative pairs, where each pair includes a query q and a document d or chunk of information c not relevant to that query q. After that, a dataset DS(q) for a specific query q can be formed without taking the difficulty of the negative examples into account, such as in the following manner.

$$DS ( q , d ) : \text{=} \{ q \} \times {DS}_{+} ( q , d ) \times {DS}_{-} ( q , d ) \qquad ( 7 )$$

$$DS ( q ) = {⋃}_{d} DS ( q , d )$$

Note that other or more sophisticated techniques may also be used here.

One challenge that can be overcome here relates to the formation of the datasets DS₊(q) and DS₋(q). Of the two, it may be more challenging to mine positive examples DS₊(q) in some cases. This is because it may be harder and involve more domain-specific techniques to source meaningful and “hard” positive examples in the dataset DS₊(q) for a broad distribution of queries q. In contrast, once positive pairs in the dataset DS₊(q) are constructed, there are generally applicable techniques for constructing irrelevant negative examples in the dataset DS₋(q) for the same queries from an unlabeled corpus.

### Chunk-Centric Approach for Training Data Generation

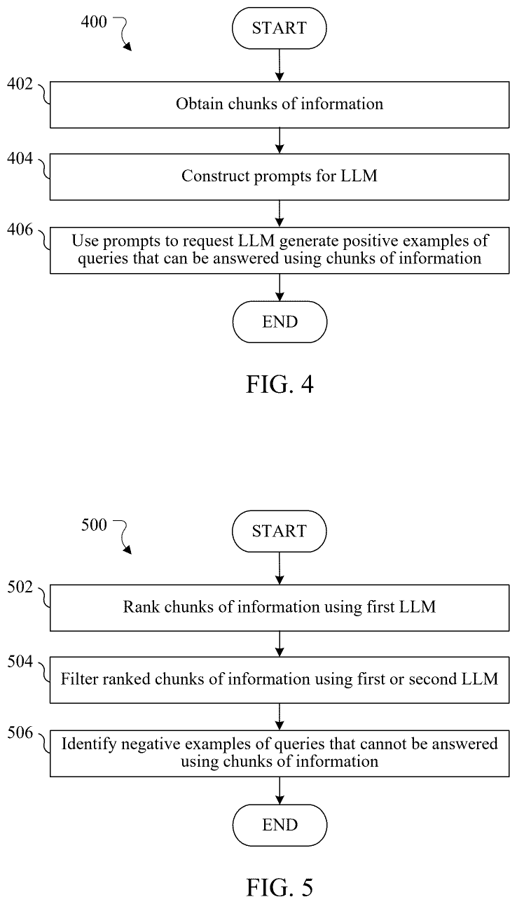

The “chunk-centric” approach for generating training datasets generally operates to produce potential input queries based on known documents d or other chunks of information c. FIGS. 4 and 5 illustrate an example implementation of a chunk-based dataset generation according to this disclosure. More specifically, FIG. 4 illustrates an example method 400 for generating positive training examples in a chunk-based training dataset, and FIG. 5 illustrates an example method 500 for generating negative training examples in a chunk-based training dataset. For ease of explanation, the methods 400 and 500 shown in FIGS. 4 and 5 are described as being performed by the application server 106 in the system 100 shown in FIG. 1, where the application server 106 is implemented using one or more instances of the device 200 shown in FIG. 2. However, the methods 400 and 500 may be performed by any other suitable device(s) and in any other suitable system(s).

As shown in FIG. 4, multiple chunks of information are obtained at step 402. This may include, for example, the processing device 202 of the application server 106 obtaining chunks of information c from various documents d or other source(s). Prompts for at least one large language model (LLM) are constructed using the chunks of information at step 404, and the prompts are used to request that one or more LLMs generate positive examples of queries that can be answered using the chunks of information at step 406. This may include, for example, the processing device 202 of the application server 106 generating prompts that request the at least one LLM generate potential input queries based on the chunks of information. As particular examples, each prompt may represent a zero-shot prompt, a one-shot prompt, or a few-shot prompt. Each prompt can request that the at least one LLM generate a potential input query that could be answered based on one of the chunks of information c provided in that prompt. Note that the chunk of information c used in each prompt here may be referred to as a “central chunk.”

As shown in FIG. 5, multiple chunks of information are ranked using a first LLM at step 502. This may include, for example, the processing device 202 of the application server 106 using a first LLM to rank the relevance of various chunks of information c to each of various potential input queries q. In some cases, this can be done using a potentially “weaker” LLM. The potentially-weaker LLM may not be able to determine an answer for a query q on the basis of a relevant chunk of information c. However, the potentially-weaker LLM can make comparative judgments between chunks of information c. In other words, the potentially-weaker LLM can be used to determine which of multiple chunks of information c is more relevant or less relevant to a query q. The ranked chunks of information are filtered using the first LLM or a second LLM at step 504, and negative examples of queries that cannot be answered using the chunks of information are identified at step 506. This may include, for example, the processing device 202 of the application server 106 processing the ranked chunks of information c using the same LLM or a different LLM to remove any chunks of information c identified as being more relevant than a corresponding central chunk of information c.

Specific embodiments of the methods 400 and 500 may be implemented in the following manner. Note that the following details are examples only and do not limit the scope of this disclosure to these specific details only. To form a chunk-centric dataset, positive examples can be created by synthesizing input queries q, such as by using an LLM. For example, the LLM can be prompted with an “instruction” prompt, which asks the LLM to synthesize a query q that could be answered on the basis of a supplied chunk of information c (the central chunk). Negative examples can be created by retrieving all chunks of information c from a document d (such as by using a baseline retriever model), considering all chunks of information c appearing higher than the “central chunk” in the results as candidates, and filtering (relevant) candidates using the same LLM or a different LLM. By varying over a large number of random “central chunks” from a dataset, this can result in a large triples dataset.

One aspect of chunk-based dataset generation can be as follows. Fix a chunk of information c∈C (D). Let “prompt” represent a prompt that asks an LLM to generate a “high quality” query q such that the chunk of information c is relevant to the query q. In some cases, this can be expressed as follows.

$$q = LLM ( c , prompt , params ) = LLM ( c ) \qquad ( 8 )$$

Here, params represents one or more additional parameters being provided to the LLM or being used by the LLM to generate the high quality query q. With a prompt as just described, a chunk-centric positive example DS₊(q) may be defined as follows.

$${DS}_{+} ( q ) : \text{=} ( q , {c}_{+} ) , \qquad ( 9 )$$

$$where = LLM ( {c}_{+} , prompt , params )$$

$$and filter ( q , {c}_{+} ) = 1 \}$$

Here, filter ( [symbol] ) is an additional binary filter function on the candidate pair (q, c₊), which can be specified as described below as part of each particular implementation.

In common with many tasks given to LLMs, one factor in the quality of the results obtained from this strategy is the LLM parameters used. In some embodiments, these parameters can include the prompt and the filter function, as well as other parameters of the LLM and how to choose the chunks of information e in the above LLM generations. In order to specify a particular chunk-centric dataset, it is possible to specify these parameters as needed or desired in any given implementation.

One specific example of parameters for an LLM are as follows. Assume a GPT4 model with its default parameters, including a temperature of zero, is being used as the LLM. A prompt provided to the LLM could be a zero-shot prompt, a few-shot prompt, or a prompt using any other prompting strategy, such as chain/tree/algorithm of thoughts. The filter ( [symbol] ) function may be defined as follows.

$${filter}_{k , +} ( q , c ) = 1 if c ∈ {M}_{q , k} ( {d}_{c} ) , 0 otherwise \qquad ( 10 )$$

Here, d=d_{c}, where d∈D and c∈C (D). The intuition is that the query q: =LLM (c) generated by the LLM may not be relevant to the chunk of information e because of some nonzero error rate of the LLM during the query-generation task. If the chunk of information c does appear within the top k results according to the retriever model M, it is possible to use C(d) as the corpus and q as the query (anchor). Usually, one uses M=M_{baseline} in this filter, where M baseline represents a baseline filter. Previous works often use k=10 approximately. However, it has been determined that the use of this filter for this purpose may be unnecessary, as the quality of the generated queries may be adequate without filtering. However, this filter is used below for other purposes, so appropriate notation will be introduced. In effect, it is possible to think of this as using a filter with k=∞.

With respect to the choice of c∈C_{Sample}, the potential number of (q, c₊)∈DS₊(q) (for different q depending on c₊) scales linearly with |C_{Sample}|, the linear constant being the number of distinct samples q generated from the LLM conditioned on the prompt. From a training corpus |Dₜᵣₐᵢₙ|≈1×10⁵, Cₛₐₘₚₗₑ could be chosen uniformly at random in some cases of size |Cₛₐₘₚₗₑ=4×10⁴. In some embodiments, one query generation may be performed per chunk of information c. However, more sophisticated choices may be used.

Summing up the discussion of all parameters in one notation for this approach of generating the positive examples in the dataset DS₊, the entire document-centric process of forming positive pairs using an LLM and including the filter, showing all of the parameters that it depends on, could be expressed in the following notation.

$${DS}_{+} ( {C}_{Sample} \vert LLM , {M}_{baseline} , k \vert ) = \{ ( q , {c}_{+} ) \vert {c}_{+} ∈ {C}_{Sample} , q = LLM ( {c}_{+} , prompt , params ) \vert \} \qquad ( 11 )$$

As noted above, however, this represents one specific approach for forming positive pairs using an LLM, and other approaches may be used.

One example of a few-shot prompt that may be used during the formation of a chunk-centric dataset is as follows. In this example, the number of passage-question pairs n is configurable and could be set to five in some cases. A variable “seed chunk” is the chunk given to the LLM on which to produce a relevant query.

“Imagine you are an analyst asking questions about an earnings call transcript. I will give
you as examples, {n} passages, each immediately followed by a question which you, the
analyst, might ask about an earnings call transcript, and in each case the question can be
answered on the basis of the preceding passage. Finally, I will give you one more passages
from the earnings call transcript. As the analyst, ask a new question which can be answered
on the basis of the passage. If you, the analyst, can't think of any meaningful questions which
can be answered on the basis of the passage, do not try to ask a question and output ‘None’.
Limit your question to 150 characters.
Example 1
<<<
Given passage: {chunk_1};
Good Question: {question_1};
Given passage: {chunk_2};
Good Question: {question_2} ;
...
Given passage: {chunk_n};
Good Question: {question_n} .
>>>
Given passage: {seed_chunk}
Good Question:”

The following are examples of passages that may be used for the n few-shot prompt, such as raw earnings call transcript (ECT) contents.

| | |
|---|---|
| 1) | “As an organization, we have long had an entrepreneurial and growth mindset. |
| | Today, adding new business lines and cash flow streams that are synergistic with our |
| | already unique model. We have built the company to thrive across cycles, including |
| | uncertain environments like today, where we can seize opportunities and continue to |
| | set our business and portfolio apart. We'll now turn the call over to the operator for |
| | your questions.” |
| 2) | “We returned this capital to shareholders as part of the current $5 billion share |
| | repurchase authorization. The second bar reflects our cash returns to shareholders, |
| | excluding the impact of the life and annuity sale. Together, these factors reduced |
| | capital by $5.4 billion with more than $4 billion going back to shareholders.” |
| 3) | “Gross debt to trailing 12-month EBITDA was 2.6x at the end of the third quarter, |
| | while net debt to EBITDA was 2.4x. We continue to expect full year average leverage |
| | in our targeted 2.4 to 2.5x gross or 2.3 to 2.4x net ranges. Moving on to cash flow on |
| | Slide 8. Third quarter year-to-date free cash flow was negative $139 million.” |
| 4) | “Debt decreased by $344 million versus 2Q ‘22, primarily due to net repayment of |
| | $222 million of commercial paper and a $123 million decrease in Eurobond book |
| | values caused by the strengthening dollar. Our total debt to trailing 12-month non- |
| | GAAP EBITDA ratio ended the period at 2.7x, down from 2.9x in the second quarter |
| | of 2022. During the third quarter of 2022, the company paid common stock dividends |
| | in the aggregate of $99 million.” |
| 5) | “Any sense for how that might change? Do you think that's still going to be a fairly |
| | low impact? Or do you think that, that might move off? James M. Cracchiolo, |
| | Ameriprise Financial, Inc. - Chairman & CEO [55] I would say this. What we're |
| | saying is there is an increase in crediting rates and there will be as rates continue to |
| | be persistent or go up. We will make adjustments.” |
| 6) | “Dori Lynn Kesten Wells Fargo Securities, LLC, Research Division - Senior Analyst |
| | * Duane Thomas Pfennigwerth Evercore ISI Institutional Equities, Research |
| | Division - Senior MD * Joseph Richard Greff JPMorgan Chase & Co, Research |
| | Division - MD * Richard J. Clarke Sanford C. Bernstein & Co., LLC., Research |
| | Division - Research Analyst *” |

The following is a list of queries that could be used for the n few-shot prompt and might be based on example query styles the LLM is expected to follow.

1) What is the company strategy for growing the business?
2) What is the company Return on Assets (ROA)?
3) What are the company's leverage numbers (gross, net, target)?
4) How much did the company's debt change?
5) Does the company expect its credit ratings to change?
6) None

As for negative examples in the dataset DS₋(q), the following describes how the dataset DS₋(q) can be set for any q∈π₁(DS₊). One example strategy here is to randomly sample some fixed number of irrelevant chunks of information c₋ from C(d)=C(d_{c}_{₊}) for each (q, c₊)∈DS₊(q). However, this strategy may have certain drawbacks in some situations. For example, the irrelevant chunks of information c₋ may generally be so much less relevant to a query q than the relevant chunks of information c₊ that the model M=M_{baseline} will already correctly classify the triples (q, c₊, c₋) so formed by a large margin, meaning the training process may not learn from these triples. Also, some randomly-sampled irrelevant chunks of information c₋ may actually be more relevant to a query q than some relevant chunks of information examples c₊, so their inclusion may be counterproductive. To address the first issue, in some embodiments, the irrelevant chunks of information c₋ could be restricted from being drawn from the results ranked higher than the relevant chunks of information c₊ by the baseline model. In other words, the following may be performed.

$$Candidate - {DS}_{-} ( q ) : \text{=} q \times \{ {c}_{-} ∈ C ( {d}_{{c}_{+}} ) , M ( q , {c}_{-} ) < M ( q , {c}_{+} ) \} \qquad ( 12 )$$

To address the second issue, it is possible to set filter₋(q, c):=¬LLM(q? c), where ¬ indicates a logical negation operation that maps 0 to 1 and 1 to 0. The following can also be defined.

$${DS}_{-} ( q ) : \text{=} \{ {c}_{-} ∈ Candidate - {DS}_{-} where {filter}_{-} ( q , c ) = 1 \} \qquad ( 13 )$$

That is, a candidate chunk of information c may be retained if the LLM, when interrogated, responds that the chunk of information c is not relevant to the query q.

Note that, in some cases within the chunk-centric framework, there may be too many candidates to be evaluated with the LLM within reasonable time or while using reasonable resources. To help compensate for this, in some embodiments, a certain percentage (such as 20%) of the candidates may be randomly sampled for evaluation. The chunk-centric approach could be improved upon in various other ways.

### Query-Centric Approach for Training Data Generation

The “query-centric” approach for generating training datasets generally operates to use a set of potential input queries q as a starting point and identify documents d or chunks of information c relevant to those queries q. In the following discussion, assume that D is composed of one year (four consecutive quarters) of earnings call transcripts for S&P 500 companies, such as 2022 Q3, 2022 Q4, 2023 Q1, and 2023 Q2. Also, let T represent the collection of S&P 500 tickers (companies). Because there is typically one earnings call transcript per company per quarter, the choice of (quarter, company) uniquely identifies a document d∈D so that the following can be obtained.

$$D = d ( quarter , t ) with ( quarter , t ) ∈ \times T \} \qquad ( 14 )$$

Ignoring a few missing data points for now, the following can be shown.

$$\vert D \vert \approx 4 \times 500 = 2 , 000 \qquad ( 15 )$$

This defines the specific corpus D to be used.

The “query-centric” approach can also use a preset list of input queries. Here, let Q_{ECT} represent a collection of potential input queries. In some cases, these input queries can represent high-impact user queries that may be typical or common in a given application. For the present discussion, assume that the collection of potential input queries includes the following queries. Note that there are some “noisy” instances, such as near-duplicate queries, which may or may not be used.

Example Input Queries

| | |
|---|---|
| What is the company strategy for growing | Will there be any change in the company's |
| the business? | management in the future? |
| Who is the CEO of the company? Who is | How much did the company's debt change? |
| the CFO of the company? | |
| What is the company's strategy for growing | How much did the metrics reported differ |
| the business? | from projections? |
| How is the company prioritizing deploying | What is the company Return on Equity |
| its cash flow? | (ROE)? |
| What is the company's revenue growth rate? | What is the company debt ratio? |
| What is the company revenue growth rate? | How much did the company debt change? |
| What is the company view on its future | How does the company manage its foreign |
| projected cash flow? | currency exposure? |
| What is the company's view on its future | Does the company plan to restructure its |
| projected cash flow? | debt? |
| What is the company's revenue? | Does the company expect its credit ratings |
| | to change? |
| For each of the metrics reported, what is the | Is the company looking to secure financing? |
| YoY change? | |
| Does the company expect its margins to | Does the company plan to issue its stocks? |
| change? | |
| What is the company's earnings per share? | Does the company plan to buy back bonds? |
| Does the company plan to repurchase its | What is the company operation cash flow |
| stocks? | per share? |
| Summarize discussion related to the | What is the company quick ratio? |
| company's debt? | |
| Does the company plan to issue/repurchase | What is the company net cash flow per |
| its stocks? | share? |
| Does the company plan to issue dividends? | What is the company net asset value per |
| | share? |
| Is the company open to acquire another | What is the company's earnings before |
| company? | interest, taxes, depreciation, and |
| | amortization (EBITDA) in each of its major |
| | segments? |
| What is the company's total cash? | What is the company inventory turnover? |
| What is the company's net income? | What is the company gross profit? |
| What is the company net profit? | What is the company current ratio? |
| Does the company plan to repay its | What is the company account receivable |
| outstanding debt? | turnover? |
| What are the company's leverage numbers | What is the company Asset turnover? |
| (gross, net, target)? | |
| Have there been any changes in the | How much did the revenue growth and |
| company's management? | earnings per share beat or miss the |
| | consensus? |
| What is the company's operating income? | What is the company Return on Assets |
| | (ROA)? |
| How does the company manage its foreign | |
| currency exposure? | |

In some cases, as soon as access to logs of a deployed Q&A system or other system is available, it is possible to expand this set of potential input queries, such as by mining actual queries issued by users. It is therefore possible to view Q_{ECT} as a proxy for a real input query set.

In some embodiments, the queries in Q_{ECT} may be chosen according to the following criterion: they should be possible to answer on the basis of a single ECT or other document d (possibly from a single contiguous passage of an ECT or other document d) and do not require aggregation or comparison of information extracted from multiple ECTs or other documents d or from multiple passages. As a result, all retrievals may be run on chunks of information c extracted from a single ECT or other document d, and a question-answer pair can be uniquely determined by a choice of a “general” q∈Q_{ECT} and a specific t∈T. Concretely, for example, if the general query q is “What is the EPS?”, each instantiation of the query q can take the form “What is the EPS of t for this quarter?” for a specific t∈T and a specific value of the quarter. In some cases, the search can be carried out only over chunks of information c from document d for quarter t. Therefore, the entire space of question-answer pairs and potential retrieval tasks for a given quarter in the example above can be bounded as follows.

$$\vert {Q}_{ECT} \vert \times \vert {D}_{Quarter} \vert \approx 50 \times 500 = 25 , 000 \qquad ( 16 )$$

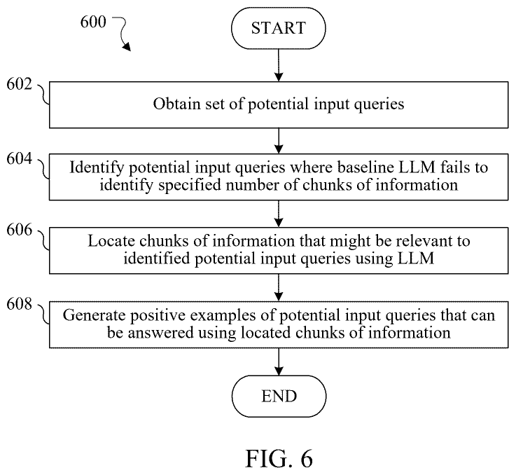

FIG. 6 illustrates an example implementation of a query-based dataset generation according to this disclosure. More specifically, FIG. 6 illustrates an example method 600 for generating positive training examples in a query-based training dataset. For case of explanation, the method 600 shown in FIG. 6 is described as being performed by the application server 106 in the system 100 shown in FIG. 1, where the application server 106 is implemented using one or more instances of the device 200 shown in FIG. 2. However, the method 600 may be performed by any other suitable device(s) and in any other suitable system(s).

As shown in FIG. 6, a set of potential input queries is obtained at step 602. This may include, for example, the processing device 202 of the application server 106 obtaining a preset list or other collection Q_{ECT} of queries q, such as the list of queries provided above. Potential input queries where a baseline LLM fails to identify a specified number of chunks of information are identified at step 604. This may include, for example, the processing device 202 of the application server 106 using a baseline LLM to identify a number of relevant chunks of information c for each of the potential input queries q in the collection Q_{ECT} and comparing the identified number of relevant chunks of information c to a threshold value (such as three or five).

For each of the identified potential input queries, chunks of information that might be relevant to the identified potential input query are located using an LLM at step 606, and the located chunks of information are used to generate positive examples of potential input queries that can be answered using the located chunks of information at step 608. This may include, for example, the processing device 202 of the application server 106 using another LLM to search for chunks of information c that the other LLM determines are relevant to the identified potential input query q. The positive examples may include the potential input queries q and the located chunks of information c identified as being relevant to those potential input queries q.

Negative examples for a query-based dataset may be produced in any suitable manner. For example, in some cases, a method that is the same as or similar to the method 500 shown in FIG. 5 could be used to identify negative examples for the query-centric technique. Here, however, the method 500 could be performed using the positive examples produced during the method 600 rather than during the method 400.

Specific embodiments of the method 600 may be implemented in the following manner. Note that the following details are examples only and do not limit the scope of this disclosure to these specific details only. A set Q_{ECT} of queries can be used as a starting point, and an LLM can be used to find, for each query q∈Q_{ECT}, the query-document pairs where a current baseline model “underperforms.” In some cases, underperformance can be defined as failing to place any relevant chunk of information c in the top k retrieval results (such as the “top 3” retrieval results) when at least one chunk of information c exists. Positive examples can represent the relevant chunks of information c as judged by the LLM, and negative examples can be formed using similar techniques as in the “chunk-centric” technique. Note that while the chunk-centric technique may be ideal for some situations, such as those starting without any given queries q, it may be necessary or desirable to leverage Q_{ECT} and find a set of positive examples (q, c₊) that a current baseline model M_{baseline} is not retrieving within M_{q,k} (C(d)). The query-centric approach can offer a solution in those or other cases.

In the query-centric approach, a pair (q, d)∈Q×D is said to be in the support of a dataset DS when d=d_{c}_{₊} for some triple (q, c₊, c₋)∈DS, where supp (DS) represents the set of all such (q, d). In some embodiments, example designs of the query-centric dataset may satisfy the following three conditions. First, supp (DS) can be a subset of Q_{ECT}×D_{training}, which can be guaranteed in certain implementations. Second, the current baseline model M baseline “fails” or delivers suboptimal performance on (q, d) in the sense that, letting Rel_{q}(C(d)) represent the chunks of information c∈C(d) that are “ground-truth relevant” to a query q, M_{q,k} (C(d))∩Rel_{q}(d) is empty but Rel_{q}(d) is not empty. In other words, supp (DS) may be exclusively focused on a small portion of the entire space Q_{ECT}×D_{training}, precisely the portion where the baseline model M baseline is weakest as a retriever and from which the model can learn the most. Third, the labeling of C(d) for (q, d) E supp (DS) can be exhaustive in the sense that, for (q, d) in supp (D), each c∈C(d) is assigned to one of Rel(q, C(d)) (a relevant dataset) or Irrel(q, C(d)) (an irrelevant dataset). Among other things, this may enable the calculation of certain IR metrics such as IDCG and NDCG.

With respect to creating positive examples using the query-centric approach, the following describes examples of how to construct positive examples DS₊(q) efficiently and with little or no user annotations in order to satisfy these three conditions. Conceptually, one way to form positive examples DS₊(q) for fixed (q, d) is to use an LLM as an “oracle” source for ground truths. Thus, for instance, imagine the following scenarios.

In a first scenario, an LLM can be interrogated once for each q∈Q, c∈C(d), and (q, c). Here, a chunk of information c∈C(d) can be included in the positive examples DS₊(q, d) when (i) LLM(q? c)=1⇔c∈Rel(q, C(d)) and (ii) LLM(q? c′)=0⇔c′∈Irrel(q, C(d)) for all c′∈M_{q,k} (C(d)), c′≠c. By definition, a dataset formed in this manner would satisfy the three conditions above. Note that if this approach is used to construct the dataset, many calls to the LLM might have to be made, such as |Q×C(D)|, which may be on the order of 1×10⁷ for a specified Q and corpus. One goal here may be to massively prune the search space by finding a way of cheaply identifying promising candidates. One example approach for doing so can be expressed as follows.

$${c}_{+} ∈ {M}_{q , > k} ( d ) : \text{=} C ( d ) - {M}_{q , k} ( C ( d ) ) \qquad ( 17 )$$

Here, if no promising candidates are found for (q, d), (q, d) is excluded from the support of DS, and the next (q, d) is analyzed. In case some candidate c₊ is found, only one call for each candidate to the function LLM(q?·) may be made, which is far fewer than |C(D)| calls. Note that when a potentially-weaker LLM is used to more comparisons between two chunks of information c_{A} and c_{B}, the following notation can be used.

$${LLM}^{′} ( q ? {c}_{A} : {c}_{B} ) \qquad ( 18 )$$

This roughly means that the potentially-weaker LLM (denoted LLM′) is asked to compare the relevance of chunks of information c_{A} and c_{B} to query q. In some cases, the output (after post-processing) can be “1” to indicate c_{A}, “−1” to indicate c_{B}, or “0” for a tie. As a natural extension of this, it is possible to define the following for any set of chunks of information C′.

$${LLM}^{′} ( q ? {c}_{A} : {C}^{′} ) := m e a {n}_{{c}_{B} ∈ {C}^{′}} {LLM}^{′} ( q ? {c}_{A} : {c}_{B} ) \qquad ( 19 )$$

Given that, the following can be obtained.

LLM′(q?c:M_{q,k}(C(d)))=1⇔LLM′(q?c:c′)=1for all c′∈M_{q,k}(C(d)) (20)

In a second scenario, the potentially-weaker LLM can be interrogated once for each chunk of information c∈C(d)−M_{q,k} (C(d)). Here, (q, c) can be included as a positive example DS₊(q, d) when LLM(q? c)=1⇔c∈Rel(q, C(d)). In the second scenario, it is not difficult to see that, under certain assumptions, the positive examples DS₊(q, d) will include roughly the same set as in the first scenario. Intuitively, the explanation is that a chunk of information c∈C(d)−M_{q,k} (C(d)) can only be relevant, and all of M_{q,k} (C(d)) can be irrelevant, if it is more relevant than all chunks of information c′∈M_{q,k} (C(d)) and the chunk of information c is itself relevant. Unlike in the first scenario, only as many calls to the LLM as the number of c∈C(d)−M_{q,k} (C(d)) are needed. The following is pseudocode for an example algorithm for forming a query-centric dataset.

```
Input: q ∈ Q, d ∈ D
Output: DS₊(q, d) ⊂ C(d)
Initialize: Retrieve $\text{?} ( C ( d ) ) = [ {c}_{l}^{′} , … , {c}_{k}^{′} ] \text{?}$ ordered by rank, LLM′(q, d, M, K, i) [symbol]
(d), r = 1
For r in [symbol]  k
  If LLM′(q, d, M, K, 1) is empty, break
  ${LLM}^{′} ( q , d , M , K , \text{?} ) - [ c ∈ {LLM}^{′} ( q , d , M , K , \text{?} ) \vert {LLM}^{′} ( q : c : {c}_{r}^{′} ) = \text{?}$
Return: {c ∈ LLM′ (q, d, M, K, 1) |LLM(q, c) = 1|) [symbol]
indicates data missing or illegible when filed
```

Note that there are some additional optimizations that may be made in this pseudocode to decrease the number of LLM′(q? c_{A}:c_{B}) evaluations to be performed. For example, to further increase efficiency, these evaluations can be highly batched.

As for negative examples DS₋(q), some fixed number of irrelevant chunks of information c₋ can be randomly sampled from C(d)=C(d_{c}_{₊}) for each (q, c₊)∈DS₊(q) as described above. However, as described above, this strategy may have two drawbacks in some situations. Namely, the irrelevant chunks of information c₋ may generally be so much less relevant to a query q than the relevant chunks of information c₊ that the model M=M baseline will already correctly classify the triples (q, c₊, c₋) so formed by a large margin, and some randomly-sampled irrelevant chunks of information c₋ may be more relevant to a query q than the relevant chunks of information c₊. To address the first issue, in some embodiments, the irrelevant chunks of information c₋ for the negative examples DS₋(q) can be restricted to being drawn from the first k retrievals of the baseline model anchored at a query q with a corpus C(d_{c}_{₊}). This can be expressed as follows.

$$Candidate - DS\_ ( q ) := q \times \{ c\_ ∈ {M}_{q , k} ( {d}_{{c}_{+}} ) \} \qquad ( 21 )$$

The second issue can be addressed in the same manner as was done in the chunk-centric technique.

Note that, in some cases within the query-centric framework, there may not be enough negative or positive examples. In those cases, the standard parameter choice k=10 for the positive example mining may be reduced, such as to k=3. This can lead to more candidates and eventually more positive examples, which in some instances may lead to more than twice as many positive examples as before. For the negative example mining in the query-centric framework, k can be increased, such as from k=3 to k=5, which in some instances may result in more than twice as many negative examples as before. The query-centric approach could be improved upon in various other ways.

### Trained Retriever Model Evaluation

By using the chunk-centric technique or the query-centric technique described above, it is possible to generate training data, such as triples having the form (query, more relevant document/chunk, less relevant document/chunk). A sentence transformer 300 or other embedding model can be trained using the generated training data, and the resulting trained embedding model can be placed into use, such as when deployed to one or more other devices or otherwise placed into use as a retriever model 112.

In order to understand the effectiveness of the training based on training data generated in this manner, some estimate of what percentage of the question-answer pairs actually exist in the corpus may be needed. In the context of the earnings call transcript (ECT) example, for instance, knowledge of which (q, t) an actual answer to a query q can be found in a document d (quarter t) may be needed. In some cases, based on evaluation, this value may be about 30% and possibly somewhat less (although it can vary depending on the circumstances and the use case). Thus, in one example, there may only be about 8,000 “useful” query-document pairs per quarter (out of a possible 25,000 documents) on which to evaluate the retrieval system and no simple way to tell beforehand when a query-document pair will be “useful,” meaning it contains an answer to a query q. Also, the distribution of useful query-document pairs over queries q can be very non-uniform, with some queries q having answers within most documents d and other queries q having answers within just a handful of documents d per quarter t. The sparse and non-uniform distribution of useful query-document pairs can impose a limitation on the current round of dataset formation/evaluation, which is one example motivation for the second evaluation technique described below.

Beyond the fundamental properties and limitations of the dataset, the chunking method can also be specified, where the chunking method defines how documents d are divided into chunks of information c. In some embodiments, chunking can be carried out with a spaCy NLP library. Also, in some cases, the chunking method can be used to produce chunks of information c having a length no larger than a certain number of characters within the constraints of respecting sentence boundaries or (if that is not feasible) word boundaries. As a particular example, the maximum number of characters per chunk of information e could be set to 450 characters. Empirically, this method may result in each ECT being approximately 200-300 chunks long, which would theoretically give around 1×10⁵ chunks for each quarter. Because of some missing data, the results in one specific example may be closer to around 4×10⁴ chunks per quarter. Note that it is assumed below a fixed chunk size is used, although varying the chunk size can be analyzed to determine if a different chunk size might be beneficial in particular implementations. Based on the ECT example above, a thorough evaluation of the performance of any retriever model M on one quarter's worth of raw data can amount to the retrieval of approximately 25,000 lists M_{q,k}(d), as the query q ranges over 50 possibilities and the document d ranges over 500 possibilities, and the evaluation of one or more IR metrics such as DCG@k, NDCG@k, and MRR on each.

As noted above, the retrieval step itself can be carried out very efficiently, but challenges to accomplishing this evaluation at scale may include the following. First, the corpus can be unlabeled, and there may be little or no resources for annotation and no user engagement data. Computations of IR metrics typically assume a ground truth relevance judgment for each chunk of information c, which may not be immediately available. As described above, this challenge can be overcome to some extent using LLMs. While applying LLMs to many different retrieval sets can become time- and resource-consuming, ways of optimizing the application of LLMs have been provided above. Second, even assuming the availability of some method to label the top k documents with M_{q,k}(d), there is no way of knowing if any relevant chunks have been missed. For example, when no relevant chunks are retrieved within the top k set, there may be no way of knowing if the query q has an answer in document d without having a LLM examine each chunk of information c in the document d. Creative ways of leveraging less-powerful but still-capable LLMs have been described above to avoid doing this while having (approximately) the same effect. Third, in addition to the sparsity of question-document pairs with definite answers, the question-answer pairs on which any two “near” state-of-the-art models are likely to differ significantly in retrieval performance is even sparser in the space of total question-answer pairs. Thus, a totally-exhaustive (or even random) evaluation method is likely to be wasteful of time and resources, and a more effective strategy is to focus on query/document pairs with stark differences was described above.

Various sentence transformers or other models can be used to generate embeddings, and the models can be used to generate accurate vector representations of words or sentences that can be used for a variety of tasks. Both open-source models of different sizes and commercially-available (proprietary) models could potentially be used here, allowing for a comprehensive analysis of the available embedding models. In some cases, when performing a comprehensive analysis, models can be chosen in order to include (i) models achieving state-of-the-art performance, (ii) models with different architectures, (iii) models with a large range of model sizes, and/or (iv) models that include both open-source and commercially-available models. Specific examples of embeddings models that might be evaluated could include the following: the current stable version of the textembedding-gecko@001 model provided by GOOGLE Vertex AI; OPENAI Ada embedding models like the text-embeddings-ada-002 model; instructor models like instructor-base, instructor-large, and instructor-x1 models; and GTE models like the GTE-small, GTE-base, and GTE-large models. Any or all of these models may be trained using one or more training datasets generated as described above and used as a retriever model 112 with one or more generative models 114. Of course, any other or additional models may be evaluated or used here.

Various techniques may be used to evaluate the performance of a trained retriever model 112, such as for comparison to the performance of one or more other trained retriever models 112. In the following discussion, two different evaluation techniques are described, which are referred to as a “query-centric” technique and a “model-centric” technique. In some cases, both evaluation techniques keep the corpora for training and evaluation separate, and the entire corpus for training is prior to the entire corpus for testing in keeping with usual best practices in IR (although neither condition is necessarily required). Using the earnings call transcripts example above, the particular choice of the training corpus and the test corpus used to achieve this may be defined as follows.

$${D}_{train} = D ( 2022 Q 3 , 2022 Q 4 , 2023 Q 1 ) \qquad ( 22 )$$

$${D}_{test} = D ( 2023 Q 2 )$$

In addition, common to many evaluation techniques is that attention is restricted to only two models M to evaluate at one time, where one mode is designated as the baseline model M_{baseline} and the other model is designated as the experimental model Mₑₓₚ (sometimes referred to as a “challenger” model). This helps in various ways with computational complexity.

### Query-Centric Approach for Model Evaluation

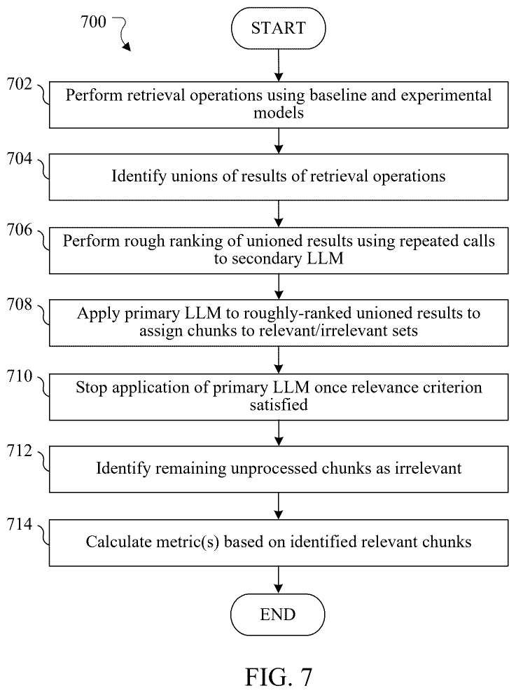

A “query-centric” evaluation of a model can generally involve evaluating the performance of the model by performing a large number of retrievals using the model based on a large number of input queries and evaluating the retrieval results. FIG. 7 illustrates an example implementation of a query-centric technique to evaluate the performance of a trained embedding model according to this disclosure. More specifically, FIG. 7 illustrates an example method 700 for evaluating the performance of a retriever model 112 using a query-centric evaluation technique. For ease of explanation, the method 700 shown in FIG. 7 is described as being performed by the application server 106 in the system 100 shown in FIG. 1, where the application server 106 is implemented using one or more instances of the device 200 shown in FIG. 2. However, the method 700 may be performed by any other suitable device(s) and in any other suitable system(s).

As shown in FIG. 7, retrieval operations are performed using a baseline retriever model and an experimental retriever model at step 702. This may include, for example, the processing device 202 of the application server 106 obtaining chunks of information c from various documents d using a baseline model M_{baseline} and an experimental model Mₑₓₚ. Each model can be used to identify the top k chunks of information c contained in the documents d in response to different queries q. Unions of the retrieval results are identified at step 704. This may include, for example, the processing device 202 of the application server 106 determining, for each query q, all of the chunks of information e identified by the baseline model M_{baseline} and/or the experimental model Mₑₓₚ in response to that query q.

A secondary LLM is used to perform a rough ranking of the unioned results at step 706. This may include, for example, the processing device 202 of the application server 106 using a potentially-weaker LLM to compare the relevance of different pairs of identified chunks of information c for each query q. This can effectively divide the unioned retrieval results into levels or rungs, such as five rungs. The highest rung can be associated with maximum relevance, while the lowest rung can be associated with minimal relevance. This can be said to result in a partial ordering of the unioned retrieval results.

A primary LLM is applied to the roughly-ranked unioned results in order to assign the chunks of information to relevant/irrelevant sets at step 708. This may include, for example, the processing device 202 of the application server 106 querying the primary LLM by asking whether each chunk of information c in a rung is relevant to a given query q. The primary LLM may respond by indicating that each specified chunk of information c is or is not relevant to a given query q. Note that this can start with the chunks of information c in the highest rung and work downward. This process can continue until some relevance criterion is satisfied, at which point the process can stop at step 710 and any remaining unprocessed chunks of information can be classified as irrelevant at step 712. This may include, for example, the processing device 202 of the application server 106 detecting that a rung of the unioned retrieval results contains no relevant chunks of information c, at which point it may be assumed that all lower rungs also contain no relevant chunks of information c.

One or more metrics can be generated for the baseline and experimental models based on the chunks of information identified as being relevant at step 714. This may include, for example, the processing device 202 of the application server 106 calculating one or more metrics for the baseline model M_{baseline} and the experimental model Mₑₓₚ. In some cases, a difference between a metric for the experimental model Mₑₓₚ and a metric for the baseline model M_{baseline} can be divided by the metric for the baseline model M_{baseline} in order to produce a normalized delta metric for the experimental model Mₑₓₚ. Doing this across all experimental models can provide a mechanism for comparing the operations of the experimental models.

Specific embodiments of the method 700 may be implemented in the following manner. Note that the following details are examples only and do not limit the scope of this disclosure to these specific details only. With respect to an example of the query-centric evaluation, one direct way of evaluating the performance of a model M would be to perform a large number of retrievals and evaluate the results. That is, the model M can be used to form as many of the following ordered lists as possible.

$${M}_{q} ( C ( d ) ) , for q ∈ {Q}_{ECT} , d ∈ {D}_{test} \qquad ( 23 )$$

One or more IR metrics (such as RR, NDCG, etc.) can be evaluated based on the results. One challenge with this strategy may be the lack of relevance ground truth labels for the documents d or equivalently the ideal ordering of the documents d in C(d) with respect to relevance to the query q. One straightforward way of using a generative performant LLM in this evaluation would be to use the LLM to label each chunk of information c∈C(d) in terms of its (degree of) relevance to a query q. In some cases, this process can be formalized by defining a zero-shot or other instruction prompt template that asks the LLM to answer the query q on the basis of a chunk of information c, where q and c are variables that can be substituted into the template to form a concrete prompt. The prompt can also include instructions to respond with a particular word (such as “None”) if the query q cannot be answered on the basis of the chunk of information c.

This approach can therefore be defined as follows. Let LLM(q, c|prompt) represent the text that the LLM generates. Also, let LLM(q? c)=0 if the response is negative and let LLM(q? c)=1 otherwise. A “negative response” is one that is just the word “None” or that contains some other expression (such as “does not provide”) the LLM uses to indicate that the query q cannot be answered on the basis of the chunk of information c. In some cases, the function LLM(q? c) can be implemented by applying a simple regular expression (regex) function to the raw output LLM(q, c|prompt) of the LLM, but the details of this function may be changed depending on the precise LLM used.

As a particular example, a prompt having the following form could be created and supplied to an LLM: “You are a helpful assistant with knowledge of financial reporting. Answer the question ‘{q}’ on the basis of the passage ‘{c}’. If you cannot answer the question on the basis of the passage, do not make up an answer. Instead respond with ‘None’.” The response from the LLM can undergo post-processing to obtain a binary decision {0, 1}, where “0” is output if the raw output from the LLM is simply “None” or contains a phrase like “passage does not provide” or “it does not provide” and a “1” is output otherwise. One possible issue with the above strategy may be that it involves |Q|×|C|≈500×2×10⁵=10⁸ generations from the LLM, which may be expensive both computationally and financially, while it is known that the vast majority of the chunks of information c in C(d) are irrelevant to any given query q.

In order to evaluate the LLM on a much smaller subset of C(d), two operations may be adopted. First, it is possible to take advantage of the fact that only two retriever models 112 are being compared at the same time and that the retrieve-then-read system may likely take only a limited number of top results into account (say k=10) to restrict attention to M_{baseline}(q, d, k) and Mₑₓₚ(q, d, k). Although this may mean that only MRR@k and DCG@k metrics are computed, one benefit is that the number of potential relevance judgments that need to be taken for each (q, d) pair is only between k and 2k, not |C(d)|. Nevertheless, this may still represent a large number of LLM calls, such as up to |Q|×|D|×2k≈5×10⁵ in the example setting. Second, it is possible to leverage the potentially-weaker LLM, which may not be able to answer the query q on the basis of a relevant chunk of information c but which can make comparative judgments with regards to relevance. Thus, a second prompt template and LLM-based function can be formalized for re-use. The second prompt template can take variable strings q, c_{A}, c_{B} and, when instantiated with particular passages, used to ask the potentially-weaker LLM which of chunk of information c_{A} (passage “A”) or chunk of information c_{B} (passage “B”) is more relevant to a query q. The second prompt may include instructions to the potentially-weaker LLM to output “neither” if both are equally relevant or irrelevant (tic).

This approach for using the potentially-weaker LLM may be defined as follows.

$${LLM}^{′} ( q ? {c}_{A} : {c}_{B} ) = 1 if {LLM}^{′} ( q , {c}_{A} , {c}_{B} ) includes “ A ” and not “ B ” ; \qquad ( 24 )$$

$$- 1 if {LLM}^{′} ( q , {c}_{A} , {c}_{B} ) includes “ B ” not “ A ” ; and 0 otherwise$$

The union of two retrieval@k sets for the baseline and experimental models be defined as follows.

$${M}_{\{ b , e \} q , k} := {M}_{baseline , q , k} ( C ( d ) ) ⋃ {M}_{exp , q , k} ( C ( d ) ) \qquad ( 25 )$$

Note the following condition can be true here.

$$k \leq \vert {M}_{\{ b , e \} q , k} \vert \leq 2 k \qquad ( 26 )$$

One goal of the query-centric technique can be to estimate the relevance of M_{{b,e},q,k} based on interrogating an LLM. In some embodiments, LLM′(q? c_{A}:c_{B}) can be evaluated by making one evaluation of LLM′(q? c_{A}:c_{B}) and one evaluation of −LLM′(q? c_{B}:c_{A}) and returning a nonzero answer only if they agree, which can be done in order to correct for some observed bias of LLM′ to answer “A” in preference to “B.” In some embodiments, the potentially-weaker LLM may represent the GOOGLE flan-t5-xxl model, although other LLMs may be used here.

As a particular example, the prompt given to the potentially-weaker LLM may have the following form: “Given two texts ‘A’ and ‘B’, tell me which is more relevant to the query {q}: text A is ‘{c_{A}}’, text B is ‘{c_{B}}’. You should not answer anything but the following: ‘A’, ‘B’, ‘Both equally’, or ‘Neither’.” The response from the potentially-weaker LLM can undergo post-processing to obtain a decision {−1, 0, 1}, where “1” is output if “A” is contained in the answer but not “B”, “−1” if “B” is contained in the answer but not “A”, and “0” otherwise. In some cases, it is possible to perform a consistency check by obtaining a result of LLM′(q?c_{B}: c_{A}) and negating the result, at which point either the common result or a “0” can be returned.

By making repeated calls to LLM′(q? c_{A}:c_{B}) with c_{A}, c_{B} drawn stochastically from M_{{b,e},q,k}, it is possible to partition M_{{b,e},q,k} into n (roughly equally sized) rungs with the n^{th} or highest rung denoting maximum relevance and the first or lowest rung denoting minimal relevance. LLM(q?·) can be applied to the partially-ordered chunks of information C∈M_{{be},q,k}, working down the rungs (such as from the 5-* rung to the 1-* rung) until some criterion is met according to which the potentially-weaker LLM can stop and declare that any remaining chunks of information c in any remaining lower rungs are irrelevant. The following goes into more detail on how this can be accomplished.

There are well-accepted techniques for efficiently extracting partial rankings from pairwise comparisons. For example, it is possible to modify the algorithm from Heckel et al., “Active Ranking from Pairwise Comparisons and the Futility of Parametric Assumptions,” 2016 (which is hereby incorporated by reference in its entirety). In some cases, n (the number of rungs) can be fixed at five, as this seemed to strike a balance between computation efficiency of the grouping into rungs. However, other values for n may be used. Also, the space of the chunks of information c for which the function LLM(q?·) has to be applied can be pruned. For instance, with k=10 and n=5, there may be between two and four chunks of information c per rung, meaning 2≤|i−*|≤4. Finally, one example of an algorithm used to assign relevance rankings to the tiered elements of M_{{b,e},q,k} is provided below. Note that the notation used (from 5-* to 1-*) is taken from literature on “Likert” scales.

In the following algorithm, while the initial assignment of chunks of information c ∈M_{{b,e},q,k} to rungs may be imperfect, the assignment is adequate in the following sense. While working down the rungs, if a rung is encountered in which all documents d or chunks of information c are evaluated as “irrelevant” by the LLM, it can safely be assumed that all lower rungs also (most likely) include irrelevant documents d or chunks of information c. In that case, the algorithm can be terminated, and all remaining documents d or chunks of information c in lower rungs can be assigned a value of “0” (indicating irrelevance) without explicitly passing them through the LLM prompt LLM(q?·).

```
Given: Ordered sets of chunks c ∈ M [symbol] from 5−* to 1−*.
i−*:= [symbol] c [symbol] ...c [symbol] . M [symbol] =∪ [symbol] −*).
Return: chunk_to_relevance, a mapping whose keys are c ∈ M [symbol] and
whose values belong to [symbol] 0, 1 [symbol]
Initialize: i=5, chunk_to_relevance= [symbol] .
While i ≥ 1:
  Evaluate LLM(q, c) for c ∈{c [symbol] c [symbol] }, and assign
chunk_to_relevance[c] ← LLM(q, c).
  i−=1.
  If all (LLM(q,c) == 0 for c ∈ {c [symbol] c [symbol] }):
    break
Assign chunk_to_relevance(c) [symbol] for ∪ [symbol] (m−*). [symbol]
indicates data missing or illegible when filed
```

Here, the notation i-*: ={c_{i,0}, . . . , c_{i,j}} defines a relevance rung such that, according to the LLM, c_{i,t} is more relevant that c_{i+1,l′} for all [symbol] , [symbol] . This operates to assign each chunk of information c to one of Rel(q, C(d)) or Irrel(q, C(d)) depending on the decision by the LLM, which could be expressed as follows.

$$c ∈ Rel ( q , C ( d ) ) if LLM ( q ? \cdot ) = 1 and c ∈ Irrel ( q , C ( d ) ) if LLM ( q ? \cdot ) = 0 \qquad ( 27 )$$

Once the relevance criterion is met, all remaining unprocessed chunks of information c may be assigned to Irrel(q, C(d)).

As noted above, the algorithm from Heckel et al. can be modified for use here. More specifically, the following hyperparameter is used in this algorithm.

$$δ = 0.5 ( tolerance of error parameter ) \qquad ( 28 )$$

Because the original algorithm is designed for a setting where outcomes of head-to-head comparisons are stochastic and outcomes of comparisons are deterministic, it may not be necessary to run the algorithm until the termination condition is met. It may also be impractical because, even with δ set to the relatively large 0.5, it may take very long to terminate. Therefore, a parameter “limit_on_t” can be used, which has the algorithm artificially terminate after t rounds. After t rounds, some rungs have free space, and these rungs are referred to as “partially empty”. Some objects are already assigned to rungs, and those that are not (called “unassigned objects”) have scores stored in the last row of \hat{τ}ᵢ. The objects that have not already been assigned to rungs (if any) can be sorted by score in descending order. Starting with the first partially empty rung, the rung can be filled with the highest-scoring unassigned objects, moving onto the next partially empty rung as soon as the current rung is filled. When this process terminates, all objects are assigned, and all rungs are filled in a way that is consistent with the assignment made by the partially completed algorithm and the scores obtained for the unassigned objects. In some embodiments, limit_on_t=5. While this may not seem like a large number of rounds, recall that each round of the algorithm involves |\mathscr{S}| comparisons, where \mathscr{S} starts out as M_{{b,e},q,k} with a size between k=10 and 2k=20. Also, in each round, |\mathscr{S}| is the number of unassigned objects. Therefore, in practice, this parameter choice involves between approximately 50 and 100 calls to LLM(q? c_{A}:c_{B}) to make comparisons among chunks of information c in M_{{b,e},q,k}, which is enough to establish a rough partial ordering on M_{{b,e},q,k}.

Note that the above covers in detail the case of taking the mean over all query-documents or query-chunk pairs. However, the case of taking the mean over some well-defined subset is similar. Using the earnings call transcript use case as an example, the mean may be taken over all pairs where q∈Q_{ECT} is fixed. In that case, it can be said that metrics are being stratified by some factor, such as by saying that “stratifying by query” is being done. When stratifying by a factor such as query, it is more frequent to have the denominator, the metric of the baseline model, be zero when normalizing a difference between the metric of the baseline model and the metric of the experimental model. In that case, the normalized delta of the metric would be undefined.

In these or other situations, the concept of “effective support” may be used. Effective support refers to the total number of query-document pairs (retrievals) for which at least one relevant chunk of information c is in M_{{b,e},q,k}, the union of the result sets for the two models being compared. More generally, for results aggregated (averaged) by query, company, or another factor, effective support is the number of query-document pairs (retrievals) out of the total that are incorporated in the aggregated statistic for which at least one relevant document is in M_{{b,e},q,k}. The terminology “effective support” comes from the fact that any query-document pair where no relevant chunks of information e are surfaced in the top k results contributes nothing useful to the measurement. This applies whether the measurement being reported is an average over all query-document pairs or query-document pairs satisfying some restriction. Thus, only the query-document pairs in the “effective support” contribute useful information to the statistic being reported.

The query-centric approach for model evaluation provides a flexible evaluation framework that can be applied for different datasets and embedding (retriever) models to evaluate and compare the performance of the models. This enables generation of a ranking of retriever models for different tasks and to efficiently benchmark new retriever models that might be considered for specific use cases. Among other things, this allows for the training and comparison of a number of open-source and commercial (proprietary) models of various sizes.

One potential issue with this evaluation approach is that there may be many queries q with insufficient or no data, meaning there may be many queries q where neither the baseline model nor the experimental model returns any relevant chunks of information c. Different approaches may be used to address this issue. For example, in some cases, the “model-centric” evaluation approach described below may be used. In other cases, given a specified query q (such as a query q in Q_{ECT}), the best-performing experimental model out of those evaluated so far (which may be one of the models discussed above or a fine-tuned checkpoint thereof) can be used to perform a search over the whole chunk corpus C(D) (rather than simply over distinct C(d)s for d in D) simultaneously, thus obtaining M_{q,k}(C(D)) for k>>10 (such as k=1000). These results can be re-ranked and mined for chunks of information c that are relevant to the query q. When positive results (relevant chunks of information c) for the query q are very sparse in D, this may be a more efficient method of finding the few chunks of information c relevant to the query q than iterating over individual M_{q,k} (C(d)) for randomly selected d E D. There may also be ways of using domain knowledge for narrowing the search for a relevant chunk of information c for a query q to a certain document d, such as those corresponding to companies in a certain sector or of a certain market cap.

### Model-Centric Approach for Model Evaluation

A “model-centric” evaluation of a model can generally involve evaluating the performance of the model by searching for query-document pairs where the model performs poorly. In some embodiments, this evaluation can be performed by conducting a stochastic search over an entire query-document space to attempt to find query-document pairs that (i) contain an answer to the query in the document and (ii) exhibit suboptimal retrieval performance for a given model (such as the experimental or baseline model). The evaluation can be carried out over the query-document pairs identified in the stochastic search. In some cases, the model-centric approach can be applied to obtain a second set of evaluation results (in addition to the query-centric approach), possibly with an effective support roughly three times the effective support of the query-centric approach and with a much larger proportion of the queries having effective support.

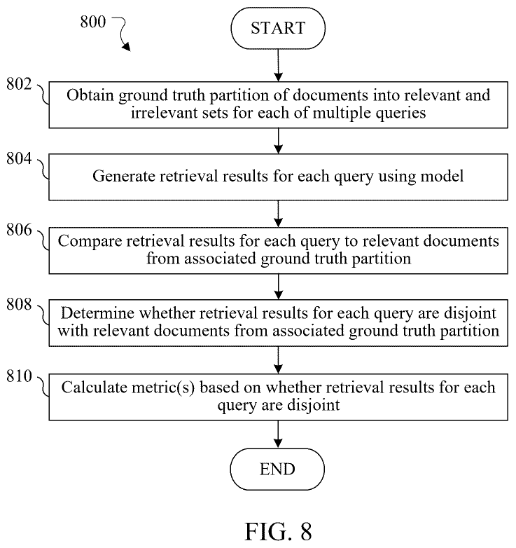

FIG. 8 illustrates an example implementation of a model-centric technique to evaluate the performance of a trained embedding model according to this disclosure. More specifically, FIG. 8 illustrates an example method 800 for evaluating the performance of a retriever model 112 using a model-centric evaluation technique. For ease of explanation, the method 800 shown in FIG. 8 is described as being performed by the application server 106 in the system 100 shown in FIG. 1, where the application server 106 is implemented using one or more instances of the device 200 shown in FIG. 2. However, the method 800 may be performed by any other suitable device(s) and in any other suitable system(s).

As shown in FIG. 8, a ground truth partition of documents into relevant and irrelevant sets for each of multiple queries is obtained at step 802. This may include, for example, the processing device 202 of the application server 106 obtaining an identification of which documents d are and are not relevant to various input queries q. Retrieval results are generated for each query using a model being evaluated at step 804. This may include, for example, the processing device 202 of the application server 106 using a retriever model 112 to obtain a set of k documents d deemed by the retriever model 112 to be most relevant for each query q.

The retrieval results for each query are compared to relevant documents from the associated ground truth partition at step 806. This may include, for example, the processing device 202 of the application server 106 determining whether any of the set of k documents d deemed by the retriever model 112 to be most relevant for each query q also appear among the documents d identified by the associated ground truth partition as being relevant. A determination is made whether the retrieval results for each query are disjoint with the relevant documents from the associated ground truth partition at step 808. This may include, for example, the processing device 202 of the application server 106 determining if there are any queries q where the retriever model 112 identified a set of k documents d in which none of those documents d is actually relevant. One or more metrics can be generated for the model based on whether the model generates retrieval results that are disjoint from the ground truth partitions at step 810. This may include, for example, the processing device 202 of the application server 106 calculating one or more metrics for the model and potentially normalizing each metric. Doing this across all experimental models can provide a mechanism for comparing the operations of the experimental models.

Specific embodiments of the method 800 may be implemented in the following manner. Note that the following details are examples only and do not limit the scope of this disclosure to these specific details only. With respect to an example of the model-centric evaluation, assume there is a ground truth partition C(d)=Rel(q, C(d))∈Irrel(q, C(d)) of C(d) into relevant and irrelevant documents d for each query q. A retriever model M may be thought of as underperforming for (q, d) provided that Rel(q, C(d)) is nonempty but disjoint from M_{q,k}(d), meaning the retriever model M retrieves none of the documents d that are actually relevant within its top k results.

The model-centric evaluation may therefore occur as follows. For each (q, d) E Supp(DS₊) for a query-centric dataset, define Rel(q, C(d)) as the relevant chunks of information c₊ such that (q, c₊)∈DS₊(q), and define Irrel(q, C(d)): =C(d)−Rel(q, C(d)). Thus, by definition, the following can be obtained.

$$C ( d ) = Rel ( q , C ( d ) ) ⋃ Irrel ( q , C ( d ) ) \qquad ( 29 )$$

This a disjoint union, and the model M is underperforming in (q, d) in these circumstances. Because there is already an implicit ground truth labeling of (q, d)∈Supp(DS₊), calculation of all IR metrics (including NDCG) can be performed efficiently on each (q, d)∈Supp(DS₊) as soon as retrieval is performed to form M_{baseline,g,k}(d) and M_{exp,q,k}(d).

Depending on the implementation, example potential advantages of model-centric evaluation versus query-centric evaluation may include the following. The model-centric evaluation can be adapted precisely to report on the (q, d) pairs in the potential test space where a model M is known to behave poorly in the sense that there are relevant chunks of information c∈C(d) but none are retrieved in M_{q,k}(C(d)), which represents the top k search results under the model M. Taking inclusion in LLM′(q, d, M, k, 1) as a proxy for relevance, IDCG and hence NDCG can be calculated because the entire C(d) is labeled for relevance to the query q.

Also, depending on the implementation, example potential disadvantages of model-centric evaluation versus query-centric evaluation may include the following. The set of (q, d) satisfying (*) may be sparse and may not be directly under control, although it is controllable in size through the parameter k. Moreover, taking M=M_{baseline}, which is the easiest option because it makes re-use of all computations done in deriving the query-centric dataset, may not be a sound option because the results can be biased against M baseline and biased towards Mₑₓₚ (the flip side of the first advantage above). In addition, calculating separate metrics by taking M=M_{baseline} and taking M=Mₑₓₚ is a more unbiased approach, but this raises additional complexity since (i) positive example mining may need to be done separately for each embedding (retriever) model and (ii) it may not be simple to combine the two separate metrics obtained into one single metric comparing M_{baseline} against Mₑₓₚ.

Even with various optimizations and parameter choices, it may take a lengthy period to run the model-centric evaluation over all choices of (q, d). For example, using the earnings call transcript use case, it may take a lengthy period to run the model-centric evaluation over all choices of (q, d)∈Q_{ECT}×D (quarter), such as when there are approximately 25,000 combinations for each quarter. Given these types of issues, some form of a sampling scheme may be used. One form of sampling could include uniform random sampling. It may be observed empirically that if (q, d) are sampled uniformly at random from Q×D in mining positive examples, the dataset DS₊ may inordinately be concentrated in certain queries q for which M_{baseline} is particularly poor. To impart more diversity within the dataset, an “active learning” sampling scheme may be used to sample with greater preference for queries q that retrieve less data but are not suffering from too many failures (in order to avoid wasting time either on the queries q that have adequate data already or queries q that are not likely to yield any new data).

For adaptive sampling of (ticker, query) pairs in mining positive examples, for instance, one goal can be to have roughly the same number of unique tickers represented in the positive set for each query q, regardless of how many chunks of information c are positive for the (ticker, query) pair. This process can be viewed as attempting to sample from |Q| (such as about 50) categories/queries, where each attempt to sample from a query/category has an unknown failure rate. This may be done to collect a final sample that is as balanced as possible in |Q| number of categories.

As an example of this, let the total number of samples to be collected be D, and let the total number of samples desired to be collected in each category be D/|Q|. Let C be the vector of counts of successful samples from each category (of length |Q|). At this point, consider iteratively sampling from the i^{th} category with (unnormalized) probability (1−C_i/(D/|Q|)), which can be 1 for any category for which there are currently no samples and tending to 0 as the number of samples of the category accumulates to D/|Q|. Normalization of the unnormalized probabilities may be achieved, such as by dividing the values above by their sum over i at any time step. In some cases, these probabilities may need adjustment if some categories have very high natural failure rates, which would be the case if, for example, certain queries have virtually no relevant passages that are not currently identified in the top k results by the current retriever model. To make the sampling procedure more robust to such circumstances, a penalty term can be included for failures so that the unnormalized probabilities now equal (1−C_i/(D/|Q|))/(1+failures_i), where failures_i is the failure count for category i. Finally, in order to prevent any categories from being permanently skipped because of a large number of failures, the failure counts can be decayed, such as by a multiplicative factor so that they are reduced to 1% (or other negligible amount) of their “normal” value after one “notional epoch” of time steps. The “notional epoch” is defined as the number of time steps one is expected to wait, on average, when sampling uniformly from the |Q| categories. In some cases, the notional epoch may be calculated by the formula given as the solution to the “Coupon Collector's Problem” (estimation method based on Euler's constant).

Note that some implementations of the two evaluations techniques described above may only focus on a limited number of queries q (such as around 50 queries). Of those queries, evaluation may be heavily weighted towards a subset of the queries q for which the most data is available, meaning the evaluations may be naturally biased towards this subset of queries q. This may explain why models trained on a query-centered dataset may have higher performance since (i) they can be formed using the same queries q and (ii) it may be more likely that the “best” model is actually overfitting to those queries q. In order to correct for this, it is possible to expand both the training and evaluation sets to a larger number and more diverse set of queries q. Several strategies may be used for this, such as mining for more documents d in the corpus that contain answers to “tail” queries q (those with small effective support). It is also possible to run the entire pipeline on a larger set of queries q, such as those originating from users of a deployed system once the system is deployed and this data becomes available.

Also note that it has been assumed above that the size of the chunks of information c is fixed to one chunk size. However, it is possible to perform simultaneous chunking of the same underlying context (documents d) with different chunk size parameters. This allows the benefits (if any) of fine-tuning a model on a chunked corpus of multiple sizes and retrieving from the same chunked corpus using different parameters to be explored. In addition, note that the triples dataset(s) can be used to train or fine-tune other machine learning models, such as a cross-encoder re-ranker. This can be done to improve the end-to-end performance of an information retrieval system, and an efficient “tuned” cross-encoder may be as significant as the embedding model for efficient retrieval.

Regardless of the exact performance of the models trained as described above, the techniques described above provide a software framework for (i) automated evaluation of dense retriever models, (ii) formation of novel training datasets for relevance embedding models, and (ii) retraining of embeddings models for relevance retrieval. With some refactoring of the software, it is possible to apply this framework to many other corpora and problem domains for retrieval-augmented generation in AI.

Although FIGS. 4 through 8 illustrate examples of implementations of dataset generation and embedding model evaluation, various changes may be made to FIGS. 4 through 8. For example, while each figure shows a series of steps, various steps in each figure may overlap, occur in parallel, occur in a different order, or occur any number of times.

### Example Processes

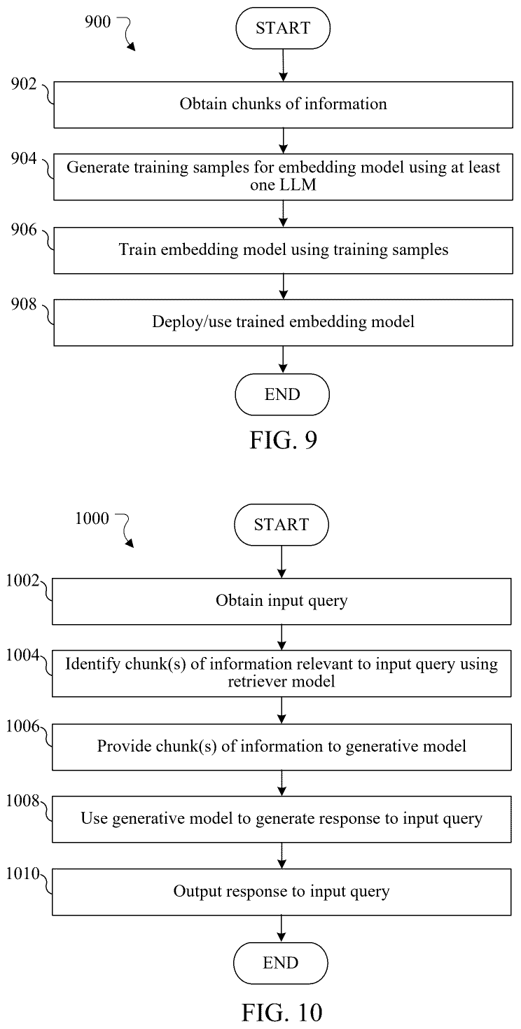

FIG. 9 illustrates an example method 900 for data generation and retraining techniques for fine-tuning of embedding models for efficient data retrieval according to this disclosure. For case of explanation, the method 900 shown in FIG. 9 is described as being performed by the application server 106 in the system 100 shown in FIG. 1, where the application server 106 is implemented using one or more instances of the device 200 shown in FIG. 2. However, the method 900 may be performed by any other suitable device(s) and in any other suitable system(s).

As shown in FIG. 9, chunks of information are obtained at step 902. This may include, for example, the processing device 202 of the application server 106 obtaining chunks of information c from various documents d or other source(s). Any suitable number of chunks of information c may be obtained here. Training samples for an embedding model are generated using at least one LLM based on the chunks of information at step 904. This may include, for example, the processing device 202 of the application server 106 using the chunk-based dataset generation technique and/or the query-based dataset generation technique described above. In some cases, the training samples can include triples having the form (query, more relevant document/chunk, less relevant document/chunk).

The embedding model is trained using the training samples at step 906. This may include, for example, the processing device 202 of the application server 106 using the training samples to train a sentence transformer 300 or another embedding model. There are various techniques known for training machine learning models, and additional techniques are sure to be developed in the future. Any suitable technique or techniques may be used here, and this disclosure is not limited to any specific training technique. The training may optionally include using the query-centric technique and/or the model-centric technique for model evaluation to determine how well the trained embedding model appears to operate. The trained embedding model can be deployed or placed into use, such as for inferencing, at step 908. This may include, for example, the processing device 202 of the application server 106 providing the trained embedding model as a retriever model 112 for use by the application server 106 or one or more other devices.

Although FIG. 9 illustrates one example of a method 900 for data generation and retraining techniques for fine-tuning of embedding models for efficient data retrieval, various changes may be made to FIG. 9. For instance, while shown as a series of steps, various steps in FIG. 9 may overlap, occur in parallel, occur in a different order, or occur any number of times. Also, at least some of the steps in the method 900 may be performed any number of times to train any number of embedding models.

FIG. 10 illustrates an example method 1000 for using fine-tuned embedding models for efficient data retrieval according to this disclosure. For case of explanation, the method 1000 shown in FIG. 10 is described as being performed by the application server 106 in the system 100 shown in FIG. 1, where the application server 106 is implemented using one or more instances of the device 200 shown in FIG. 2. However, the method 1000 may be performed by any other suitable device(s) and in any other suitable system(s).

As shown in FIG. 10, an input query is obtained at step 1002. This may include, for example, the processing device 202 of the application server 106 obtaining a user query from a user of a user device 102a-102d or other input query. The input query may have any suitable form, such as a natural language query. One or more chunks of information relevant to the input query are identified at step 1004. This may include, for example, the processing device 202 of the application server 106 using a retriever model 112 (which may include or represent an embedding model trained in accordance with the method 900 of FIG. 9) to identify one or more chunks of information relevant to the input query.

The one or more chunks of information are provided to a generative model at step 1006. This may include, for example, the processing device 202 of the application server 106 generating a prompt that includes or is based on the input query and the identified chunk(s) of information. The generative model is used to generate a response to the input query at step 1008. This may include, for example, the processing device 202 of the application server 106 providing the prompt to the generative model 114. This may also include the generative model 114 using the identified chunk(s) of information in the prompt as context when generating the response to the input query. The response to the input query is output at step 1010. This may include, for example, the processing device 202 of the application server 106 providing the response to the user device 102a-102d for presentation to at least one user.

Although FIG. 10 illustrates one example of a method 1000 for using fine-tuned embedding models for efficient data retrieval, various changes may be made to FIG. 10. For instance, while shown as a series of steps, various steps in FIG. 10 may overlap, occur in parallel, occur in a different order, or occur any number of times.

Example Retriever Models with Bi-Encoding and Cross-Encoding

The discussion above describes how to construct a dataset for retraining and evaluating retriever models 112 starting with an unlabeled corpus (such as ECT documents) and a small set Q_{ECT} of queries (such as those provided by one or more subject matter experts). However, there can be several potential drawbacks of these approaches in certain situations. For example, in some cases, there may be a small number of queries (such as when |Q_{ECT})≈40), which can make it difficult to detect or correct overfitting of a retriever model 112. Also, there can be an imbalance in the distribution of training data among the queries of the set Q_{ECT}, meaning some queries q∈Q_{ECT} may have minimal or no training data triples while other queries q∈Q_{ECT} may have an excess of training data triples. Further, within query-ticker pairs (q, t) or other evaluation data in an evaluation set, it may be that a predominance of the pairs are such that a document d(t) has no answer for a query q, meaning those pairs contribute little or no useful information or significance to the evaluation and just add computational overhead.

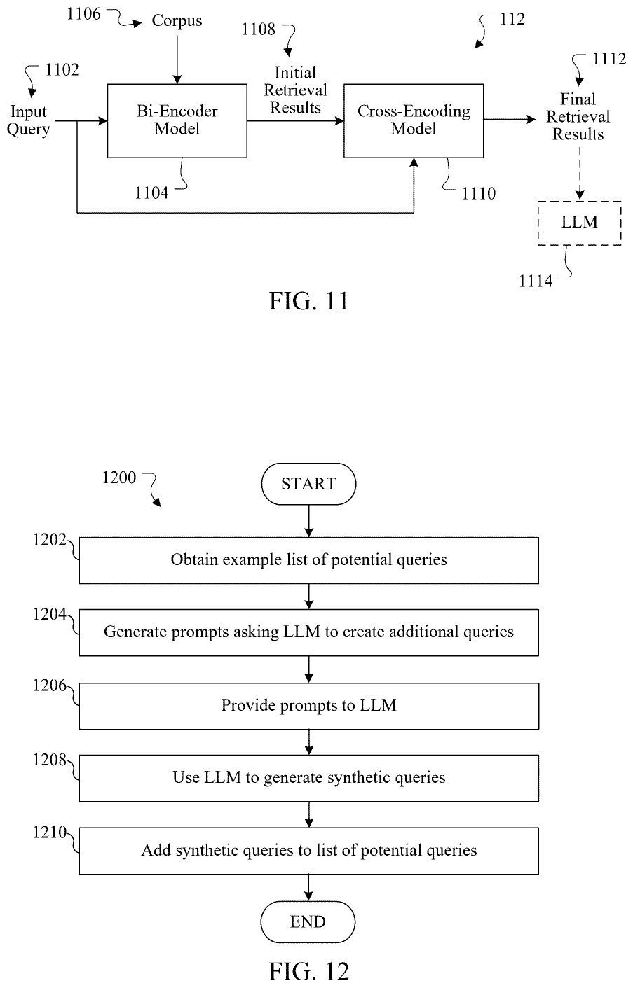

FIG. 11 illustrates an example retriever model 112 containing bi-encoding and cross-encoding models for efficient data retrieval according to this disclosure. As shown in FIG. 11, an input query 1102 is provided to a bi-encoding model 1104. The bi-encoding model 1104 also has access to a corpus 1106, which represents the documents 116 or other information from which relevant chunks of information c can be identified. The bi-encoding model 1104 can use the input query 1102 to generate initial retrieval results 1108, which represent the chunks of information c from the corpus 1106 identified by the bi-encoding model 1104 as being relevant to the input query 1102.

The bi-encoding model 1104 generally operates by embedding the input query 1102 and different chunks of information from the corpus 1106 into a vector space, thereby generating vectors that represent the input query 1102 and the different chunks of information from the corpus 1106 numerically. The bi-encoding model 1104 can determine a similarity of the vector representing the input query 1102 to the vectors representing the chunks of information from the corpus 1106, such as by using cosine distance or Euclidean distance. This allows the bi-encoding model 1104 to identify the vectors for a subset of the chunks of information from the corpus 1106 that are most similar to the vector representing the input query 1102. In some cases, this can essentially implement the functionality of the retriever models 112 described above with reference to FIGS. 4 through 10. The initial retrieval results 1108 therefore include or identify the subset of the chunks of information from the corpus 1106 that are most similar to the vector representing the input query 1102. Often times, the bi-encoding model 1104 can identify chunks of information in a ranked manner, meaning the initial retrieval results 1108 can identify the most similar chunks of information in ranked order (such as from most-similar to least-similar). A specific example of a bi-encoding model 1104 that could be used here might include a GTE-large model.

The input query 1102 and initial retrieval results 1108 are provided to a cross-encoding model 1110, which processes the input query 1102 and initial retrieval results 1108 to identify one or more chunks of information from the initial retrieval results 1108 that are most relevant to the input query 1102. For example, the cross-encoding model 1110 can re-rank or refine the initial retrieval results 1108 in order to generate final retrieval results 1112. The final retrieval results 1112 may include or identify the same chunks of information as the initial retrieval results 1108 (or at least a subset thereof), but at least some of the chunks of information may be reordered or re-ranked. That is, the cross-encoding model 1110 may identify that certain chunks of information from the corpus 1106 may be more or less relevant to the input query 1102 than initially determined by the bi-encoding model 1104.

The cross-encoding model 1110 generally operates by encoding the input query 1102 and each chunk of information included in or identified by the initial retrieval results 1108 together, allowing the cross-encoding model 1110 to encode relationships between the input query 1102 and those chunks of information. For example, the cross-encoding model 1110 may concatenate or otherwise combine the input query 1102 and each chunk of information included in or identified by the initial retrieval results 1108 and embed the resulting concatenations or combinations into a vector space. The cross-encoding model 1110 may also apply a scoring function to the resulting vectors in order to determine the similarity of the input query 1102 to each of these chunks of information. This allows, for instance, the cross-encoding model 1110 to select one or more of the chunks of information from the initial retrieval results 1108 for inclusion in the final retrieval results 1112, such as the most-relevant or most-similar chunks of information. Specific examples of cross-encoding models 1110 that could be used here might include an ms-marco-MiniLM-L-12-v2 model, a distilroberta-base model, and a roberta-large model.

As described in more detail below, during generation of training data for the retriever model 112, at least one LLM 1114 may be used to generate synthetic queries and/or identify whether chunks of information in final retrieval results 1112 are actually relevant to input queries 1102. For example, the at least one LLM 1114 may be prompted to generate potential queries based on example queries (such as known good queries). The at least one LLM 1114 may also or alternatively be prompted to provide scores or other values indicative of whether chunks of information in final retrieval results 1112 are relevant to input queries 1102, where these values can be used (among other things) to identify positive training examples for use during training of the retriever model 112.

Although FIG. 11 illustrates one example of a retriever model 112 containing bi-encoding and cross-encoding models 1104, 1110 for efficient data retrieval, various changes may be made to FIG. 11. For example, retriever models may include additional components beyond the models 1104, 1110 and the LLM(s) 1114.

Example Training Data Generation for Retriever Models with Bi-Encoding and Cross-Encoding

The following provides additional details regarding example training/fine-tuning of the retriever model 112 shown in FIG. 11. More specifically, the following describes how triples or other suitable training data can be generated in order to support training of the models 1104, 1110 within the retriever model 112. Again, in general, training samples may be generated using chunks of information, where one or more large language models are used to generate training samples. Some of the training samples (such as for the bi-encoding model 1104) can include (i) different ones of the chunks of information that are relevant to different potential input queries and (ii) different ones of the chunks of information that are not relevant to different potential input queries. Others of the training samples (such as for the cross-encoding model 1110) can include (i) different ones of the chunks of information that are relevant to different potential input queries and (ii) scores associated with those queries and chunks of information. The models 1104, 1110 of the retriever model 112 can be trained using the training samples, which allows the retriever model 112 to be used to provide relevant chunks of information to one or more generative models 114.

In the following discussion, it is assumed that a specified corpus 1106 and a pre-established list of queries Q_{ECT} are used. However, the list of queries Q_{ECT} is expanded using synthetic queries in order to produce a larger set of queries Q_{ECT}⁺. More specifically, a particular use-case is to support a retrieve-then-read pipeline backing a Q&A system giving investment analysts a conversational experience in interacting with and extracting information from Earnings Call Transcripts (ECTs) as described above. Of course, this use-case is an example only and does not limit the scope of this disclosure.

In the same manner as described above, let D denote an entire corpus, inclusive of both training and evaluation data. In some cases, this corpus may include one year (four consecutive quarters) of ECTs for S&P 500 firms, such as 2022 Q3, 2022 Q4, and 2023 Q1 (training/validation quarters) and 2023 Q2 (test quarter). Subscripting D in various ways allows one to denote sub-corpora of the entire corpus. For example, Dₜᵣₐᵢₙ may be used to denote the corpus of documents from one or more training/validation quarters or other training data, and Dₜₑₛₜ may be used to denote the corpus of documents from one or more test quarters or other testing data. Also, let C(d) denote chunks of a document, which can be created according to a suitable chunking technique (which may or may not be fixed or static). Further, let C (D) denote all chunks of the entire corpus D. In addition, let T denote the collection of S&P 500 tickers (companies). Because there is typically one earnings call transcript per company per quarter, the choice of (quarter, company) uniquely identifies a document d∈D so that the relationships expressed in Equations (14) and (15) above can be obtained.

Initially, the list of queries Q_{ECT} (which in some cases might be identified by one or more subject matter experts or “SMEs” in a relevant field) can be obtained, and the list may include queries identified as being the most impactful queries or as otherwise being useful. Examples of those queries are provided above. A pre-processing phase may be performed prior to using the list of queries Q_{ECT}, such as to remove duplicate or substantially-similar queries and/or to remove queries for which no positive examples can be mined from the corpus Dₜᵣₐᵢₙ.

Detailed discussions are provided above for generating training triples, such as by using the query-centric and chunk-centric approaches for training data generation. One difference between these two approaches is that the query-centric approach can use entirely real data, while the chunk-centric approach can use synthesized queries based on real passages from a corpus. In the following discussion, synthetic query generation is introduced into the overall framework of query-centric training data generation to combine the advantages of both approaches.

Despite the fact that models trained on query-centric datasets (versus chunk-centric datasets) might provide superior performance based on one or more specific evaluation metrics, one drawback of using a query-centric dataset is that the potential for overfitting is larger. This is because fewer queries may be represented in the dataset as a whole. Moreover, one specific evaluation technique that may be used (namely evaluating retrieval performance on Q_{ECT}, which is also used with the training dataset) would likely not detect overfitting on this set of queries Q_{ECT}. To assess potential overfitting, it is possible to have a set of queries withheld from training and only used for evaluation. With a limited number of queries, however, this can be difficult, and automated generation of synthetic queries may be used.

One way of generating synthetic queries is to use the techniques adopted in the chunk-centric dataset generation described above (such as in FIG. 4), where prompts can be built from document passages or other chunks of information and used by one or more LLMs to produce synthetic queries. However, one drawback of this approach is that it can lead to queries that, while answerable based on grounding passage, are not aligned with what actual subject matter experts or other users would ask given ECTs or another corpus. In other words, the synthetic queries that are generated may formally satisfy the requirement of having a relevant passage or other chunk of information, but the synthetic queries may not constitute or represent a realistic reflection of what users might actually desire or require. In the absence of real user interaction data, one alternative that can be adopted to address this is to generate synthetic prompts (such as via an LLM 1114) using a relatively small and very high-quality dataset of SME-supplied queries or other high-quality queries Q_{ECT}.

FIG. 12 illustrates an example implementation of synthetic query generation for use in producing a query-based training dataset according to this disclosure. More specifically, FIG. 12 illustrates an example method 1200 for generating synthetic queries for use in producing a query-based training dataset. For case of explanation, the method 1200 shown in FIG. 12 is described as being performed by the application server 106 in the system 100 shown in FIG. 1, where the application server 106 is implemented using one or more instances of the device 200 shown in FIG. 2. However, the method 1200 may be performed by any other suitable device(s) and in any other suitable system(s).

As shown in FIG. 12, a list of example queries is obtained at step 1202. This may include, for example, the processing device 202 of the application server 106 obtaining an initial list of queries Q_{ECT}, such as from one or more subject matter experts, users, or other personnel. Prompts are generated asking at least one LLM to generate additional queries at step 1204. This may include, for example, the processing device 202 of the application server 106 using a prompt template and filling in the prompt template with different queries from the initial list Q_{ECT} to generate different LLM prompts. Each prompt may provide one or more LLMs 1114 with one or more example queries from the initial list of queries Q_{ECT}, and each prompt may ask the LLM(s) 1114 to generate one or more similar queries.

The prompts are provided to the at least one LLM at step 1206, and the at least one LLM is used to generate synthetic queries based on the prompts at step 1208. This may include, for example, the processing device 202 of the application server 106 using the at least one LLM 1114 to generate input queries that are (potentially) similar to the input queries provided in the prompts. The synthetic input queries are added to the list of potential queries at step 1210. This may include, for example, the processing device 202 of the application server 106 adding the synthetic input queries to produce an updated list of queries Q_{ECT}⁺. Note that this prompting may occur any number of times until a query set Q_{ECT}⁺ of a desired or specified size is obtained. In some cases, the steps 1204-1210 may be performed one prompt at a time until a suitable query set Q_{ECT}⁺ is obtained.

This approach may be viewed as providing an LLM 1114 with a few-shot or multi-shot prompt that asks the LLM 1114 to generate one or more novel input queries that are “similar to” example queries included in the prompts. A particular implementation of this approach is shown in the following example pseudocode.

```
Input: Q_{ECT}, parameter k ∈ N, temperature t, desired N = |Q⁺|, prompt template
Output: Q_{ECT}⁺ ⊃ Q_{ECT}
Initialize: Q_{ECT}⁺ ← Q_{ECT}
While |Q_{ECT}⁺ | < N:
    Sample k elements of Q_{ECT} and substitute into prompt template to
  form prompt
    Query LLM with temperature t based on prompt and parse results
  into list LLM(prompt|temperature = t ... ) of k new queries
    Q_{ECT}⁺ ← Q_{ECT}⁺ ∪ LLM(prompt|temperature = t ... )
Return: Q_{ECT}⁺
```

The sampling of example queries from the list of queries Q_{ECT} may be performed in any suitable manner. One goal here may be to ensure that the example queries selected from the list Q_{ECT} are not overly similar to one another, which can cause automatically-generated queries to be too similar. One example technique could be uniform sampling. For example, in some implementations, the sampling can be driven by clustering to encourage greater diversity of the example queries. Clustering here may be performed outside of the loop (meaning outside of steps 1204-1210) and might be implemented using community detection or other suitable techniques. In some cases, the queries from the set Q_{ECT} can be embedded using a sentence transformer into dense vector representations, and the resulting vectors can be clustered into l≥k clusters (where k is a subset of the number of clusters randomly selected from all possible clusters l). The number of all possible clusters l could be determined by the minimum size of the community (such as the minimum number of similar questions per cluster) and a closeness threshold based on cosine similarity or other similarity of query vectors. As a particular example, l may be set to a value of 2, and the closeness threshold may be set to a value of 0.65. Sampling based on fixed clustering within each iteration of the loop could be performed as follows—k clusters may be randomly selected from the total of l clusters, and a random query can be selected from each of the k clusters. In some cases, the clustering can be performed so that example queries from different clusters are different from one another and have dissimilar embedding vectors. Other approaches may be used, such as randomly selecting from among a diverse set of exemplars.

One example of a prompt template that could be used (and revised by substituting selected example queries into the template) is provided below.

You are a seasoned financial expert meticulously reviewing earnings call transcripts with a
laser focus, and expertly crafting insightful questions to distill the critical insights trends
within. Your task is to generate a set of queries that financial experts would ask about an
earning call transcript.
Example of queries:
[BEGIN DATA]
{example queries}
[END DATA]
Generate a set of five new queries. You can familiarize yourself with the nature of queries
using the data above. Each query should be generated in a new line followed by **\\n\\n**.

The following represent example synthetic queries that might be generated using at least one LLM 1114 based on the sample queries contained in the Q_{ECT} list above, as well as based on the prompt template.

| Index | Query |
|---|---|
| 1 | Are there any changes to the company's dividend policy? |
| 2 | Are there any major business developments or announcements planned for the |
| | next quarter? |
| 3 | Are there any new investments or divestitures the company has made? |
| 4 | Are there any significant risk factors that could negatively impact the company's |
| | financial outlook? |
| 5 | Are there upcoming changes to the company's product or service lineup that |
| | might affect future revenue? |
| 6 | Can the company provide a breakdown of its major expenditures this quarter? |
| 7 | Can the company provide an update on any ongoing or pending litigation? |
| 8 | Can the company provide details on its latest acquisition or merger activity? |
| 9 | Can the company sustain its current dividend payout ratio? |
| 10 | Can you elaborate more on the company's current debt level and how it plans to |
| | manage it? |
| 11 | Can you elaborate on the company's capital expenditure plan for coming |
| | quarters? |
| 12 | Can you explain any significant fluctuation in the company's inventory levels |
| | this quarter? |
| 13 | Can you provide details on the company's cash flow from operations? |
| 14 | Can you provide details on the company's operating cash flow? |
| 15 | Can you provide insights on the company's gross margin trends for the last fiscal |
| | year? |
| 16 | Can you specify the challenges the company is facing in its operational segment? |
| 17 | Could you clarify the reasons and impact of any significant fluctuations in the |
| | gross margins? |
| 18 | Did the company beat its earnings per share (EPS) estimates? |
| 19 | Did the company gain or lose market share this quarter? |
| 20 | Did the company manage to meet its earnings forecasts? |
| 21 | Did the company meet its projected earnings for this quarter? |
| 22 | Does the company have any plans for mergers and acquisitions? |
| 23 | Does the company have any plans for mergers or acquisitions? |
| 24 | Has the company announced any significant partnerships or acquisitions |
| | recently? |
| 25 | Has the company made any recent acquisitions or mergers? |
| 26 | Has the company made any substantial investments or acquisitions recently? |
| 27 | Has the company reported any notable one-off expenses this quarter? |
| 28 | Has there been a significant change in the company's cost of operations? |
| 29 | Has there been any notable changes in the company's cash flow from operating |
| | activities? |
| 30 | Has there been any significant change in the company's operational expenses? |
| 31 | Have there been any significant changes in the company's capital expenditures? |
| 32 | How did the company fare with its earnings per share (EPS) this quarter? |
| 33 | How does the company foresee changes in the economic climate impacting its |
| | operations and financial stability? |
| 34 | How does the company intend to handle its market competition? |
| 35 | How does the company plan to drive revenue growth in the future? |
| 36 | How does the company plan to mitigate potential risks in its business operations? |
| 37 | How does the company plan to utilize its free cash flow? |
| 38 | How does the company's Gross Profit Margin compare to its competitors? |
| 39 | How does the company's gross profit margin compare to the previous reporting |
| | period? |
| 40 | How effective has the company been in managing its operating expenses this |
| | quarter compared to the same quarter last year? |
| 41 | How efficient is the company's inventory turnover rate? |
| 42 | How has the company's net profit margin been trending over the recent quarters? |
| 43 | How has the global economic situation influenced the company's financial |
| | projections? |
| 44 | How has the revenue been impacted due to the current market conditions? |
| 45 | How is the company dealing with its debt, and what is its leverage ratio? |
| 46 | How sustainable are the company's current growth rates? |
| 47 | Is the company anticipating any significant changes in its cost structure? |
| 48 | Is the company on track to meet its financial targets for the current fiscal year? |
| 49 | Is the company planning any significant capital expenditures in the near future? |
| 50 | Is there an update on the company's capital expenditure plans for the current |
| | fiscal year? |
| 51 | Is there an update on the timeline of the new product launches? |
| 52 | What actions is the company taking to improve its operating margin? |
| 53 | What are the company's Cash Flow from Operations (CFO)? |
| 54 | What are the company's current liabilities and assets? |
| 55 | What are the company's future plans regarding capital expenditure? |
| 56 | What are the company's future strategies to increase shareholder value? |
| 57 | What are the company's major areas of spending in the last fiscal year? |
| 58 | What are the company's plans for reducing operational costs? |
| 59 | What are the company's projected revenue and earnings for the next quarter? |
| 60 | What are the company's revenue projections for the next quarter? |
| 61 | What are the company's strategies for expanding its market share? |
| 62 | What are the current trends in the company's cost of goods sold (COGS)? |
| 63 | What are the key drivers behind the company's growth this quarter? |
| 64 | What are the key risks facing the company and how are they being mitigated? |
| 65 | What are the main factors contributing to the company's revenue growth? |
| 66 | What are the primary drivers of revenue growth for the company? |
| 67 | What are the risks that could potentially impact the company's future revenue? |
| 68 | What efforts are being made to improve the company's cost efficiency? |
| 69 | What factors contributed to the company's adjusted EBITDA this quarter? |
| 70 | What factors have contributed to the company's gross margin performance? |
| 71 | What is the company's current cash flow and how does it compare to the |
| | previous fiscal year? |
| 72 | What is the company's current debt level, and does it pose any potential risks for |
| | future financial stability? |
| 73 | What is the company's current debt-to-equity ratio? |
| 74 | What is the company's forecast for next quarter earnings? |
| 75 | What is the company's forecast for the next quarterly earnings? |
| 76 | What is the company's forward guidance with respect to revenue and profit for |
| | the upcoming year? |
| 77 | What is the company's gross margin for the past quarter? |
| 78 | What is the company's guidance provided for the next quarter or the next fiscal |
| | year? |
| 79 | What is the company's long-term growth strategy? |
| 80 | What is the company's net margin? |
| 81 | What is the company's net profit margin? |
| 82 | What is the company's plan for capital expenditure in the upcoming fiscal year? |
| 83 | What is the company's plan to increase its market share? |
| 84 | What is the current state of the company's cash flow? |
| 85 | What is the EBITDA margin for the recently ended quarter, and is it in line with |
| | industry averages? |
| 86 | What is the expected impact of recent market trends on the company's |
| | financials? |
| 87 | What is the forecasted sales growth for the next quarter? |
| 88 | What is the projected capital expenditure for the next fiscal year? |
| 89 | What is the projected outlook for the next fiscal year based on the current |
| | earnings report? |
| 90 | What is the projected revenue growth for the next quarter? |
| 91 | What is the year-over-year growth in the company's net income? |
| 92 | What percentage of the revenue comes from international versus domestic |
| | operations? |
| 93 | What plans does the company have for capital expenditures in the upcoming |
| | fiscal year? |
| 94 | What was the company's total debt at the end of the period? |
| 95 | What was the main cause of the change in gross margin this quarter? |
| 96 | What were the major contributing factors to the company's net profit or loss this |
| | quarter? |
| 97 | What were the top performing products or services this quarter? |
| 98 | What's the latest update on any legal or regulatory issues the company is |
| | handling? |
| 99 | What's the strategy for future international expansion? |

Based on this approach, it is possible to generate a number of synthetic queries that can be used during training of the retriever model 112 in FIG. 11. In some embodiments, t-distributed Stochastic neighbor embedding (t-SNE) representations can be used for both original and synthesized queries, which can result in a dimensionality reduction of the associated embeddings. By generating a visualization of t-SNE representations, it can be shown that synthesized queries appear to be dispersed in proximity to their corresponding original queries from the set Q_{ECT}. This indicates that there may be little if any shift in the overall distribution of the queries following the introduction of the synthesized queries to form the updated set Q_{ECT}⁺, which can be beneficial for various reasons.

Positive and negative examples can be generated based on both the actual and synthetic queries contained in the updated set Q_{ECT}⁺, which may occur in a similar manner to the approaches described above (such as with respect to FIG. 6). In some embodiments, one goal may be to mine positive examples (such as by using an existing or baseline bi-encoding model 1104) and verify that identified chunks of information are actually positive examples (such as by using at least one LLM 1114).

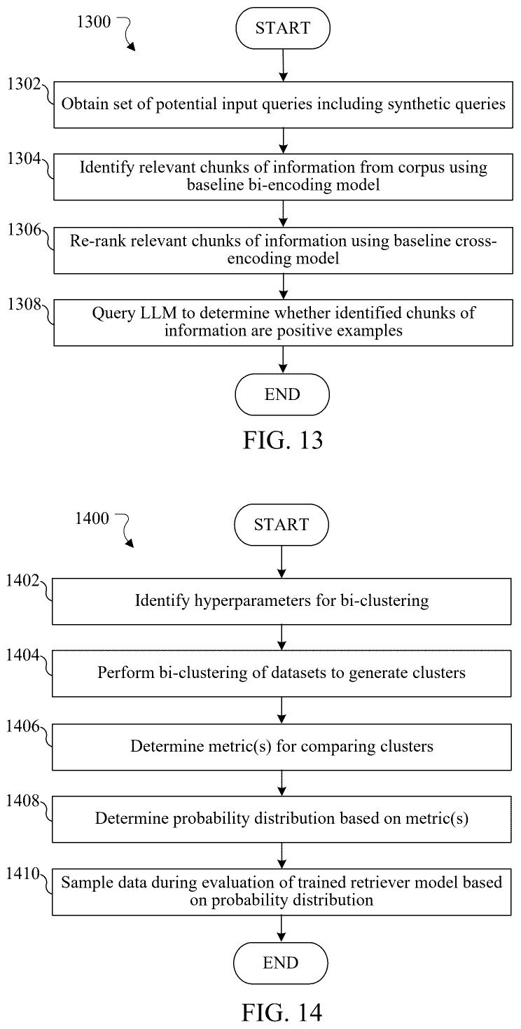

FIG. 13 illustrates an example implementation of a query-based dataset generation according to this disclosure. More specifically, FIG. 13 illustrates an example method 1300 for generating positive training examples in a query-based training dataset. For ease of explanation, the method 1300 shown in FIG. 13 is described as being performed by the application server 106 in the system 100 shown in FIG. 1, where the application server 106 is implemented using one or more instances of the device 200 shown in FIG. 2. However, the method 1300 may be performed by any other suitable device(s) and in any other suitable system(s).

As shown in FIG. 13, a set of potential input queries is obtained at step 1302. This may include, for example, the processing device 202 of the application server 106 obtaining a list or other collection Q_{ECT}⁺ of queries q, which may include a list of queries from one or more subject matter experts or other personnel and additional synthetic queries that have been generated (such as by using the techniques described above with reference to FIG. 12). For each query in the set Q_{ECT}⁺, a baseline bi-encoding model is used to identify relevant chunks of information from a corpus at step 1304. This may include, for example, the processing device 202 of the application server 106 using a baseline bi-encoding model 1104 to identify initial retrieval results 1108 that include a specified number of relevant chunks of information c for each query q. For each set of initial retrieval results generated by the baseline bi-encoding model, the relevant chunks of information may optionally be re-ranked using a baseline cross-encoding model at step 1306. This may include, for example, the processing device 202 of the application server 106 using a baseline cross-encoding model 1110 to re-rank the order of the relevant chunks of information c in the initial retrieval results 1108 for each query q to generate final retrieval results 1112 for each query q. This results in the identification of a top specified number of relevant chunks of information e for each of the potential input queries q in the collection Q_{ECT}⁺.

For the identified chunks of information for each query, at least one LLM is queried to determine whether the identified chunks of information for that query actually appear relevant to the query (and thereby represent a positive example for training) at step 1308. This may include, for example, the processing device 202 of the application server 106 generating prompts for at least one LLM 1114 based on a prompt template. Each prompt may ask the LLM(s) 1114 to determine a score for each chunk of information c, where the score indicates whether (and optionally to what extent) the chunk of information c appears relevant to a specific query q.

In some embodiments, the score for each chunk of information c may range from one to four. For example, a score of one could indicate that a query q is entirely unrelated to the contents of a chunk of information c and that the chunk of information c contains no answer to the query q. A score of two could indicate that a query q has weak relevance to the contents of a chunk of information c or that the connection between them is unclear or incomplete, so the query q cannot be answered based on the chunk of information c. A score of three could indicate that a query q is relevant to the contents of a chunk of information e and shows a clear connection, but there may be some gaps or minor inconsistencies in relevance (meaning, to answer the query q accurately based on the chunk of information e as context, the answer may be partial). A score of four could indicate that the contents of a chunk of information c are perfectly or directly relevant to a query q with a clear and complete connection between them, so an answer based on the chunk of information c would be relevant, highly accurate, and effective and explicit at answering the query q.

Negative examples may be produced for the queries in the set Q_{ECT}⁺ in any suitable manner. For example, in some cases, a method that is the same as or similar to the method 500 shown in FIG. 5 could be used to identify negative examples for the queries in the set Q_{ECT}⁺. Here, the method 500 could be performed using the positive examples produced during the method 1300 rather than during the method 400. However, other approaches could also be used here. For instance, the scoring provided by the LLM(s) 1114 can indicate that queries q are unrelated to chunks of information c and that the chunks of information c contain no answers to the queries q, and those chunks of information c can be used as negative examples for those queries q. As another example, the LLM(s) 1114 can rank positive examples as being more relevant to the queries q and rank negative examples as being less relevant or irrelevant to the queries q, such as by using the scoring technique above. However, the cross-encoding model 1110 and the bi-encoding model 1104 may rank the positive examples and the negative examples in reverse order, meaning the cross-encoding model 1110 and the bi-encoding model 1104 may rank the negative examples higher than the positive examples. This may allow the cross-encoding model 1110 and the bi-encoding model 1104 to more easily identify negative examples.

Specific embodiments of the method 1300 may be implemented in the following manner. For each q∈Q_{ECT}, the retrieval of the top K_{biencoder} chunks of information c from C (D) can be performed using the baseline bi-encoding model 1104, where D is the entire document corpus. The K_{biencoder} chunks of information c from C (D) for each query q can be re-ranked using the baseline cross-encoding model 1110, retaining only the top K_{cross_encoder} chunks of information c for each query q. Note here that the top K_{cross_encoder} chunks of information c from C(D) (meaning from the entire corpus) can be considered as candidates. A scoring prompt may be generated and provided to the LLM(s) 1114 for use in filtering positive candidates. These operations can be summarized in the follow pseudocode.

```
for q in Q_{ECT}⁺ :
  1. retrieve K_{biencoder} passages
  2. rerank K_{cross-encoder} passages
  3. score and evaluate K_{cross-encoder} passages using LLM
```

The following represents one example of a scoring prompt that may be used here and revised as described above.

You are an expert financial reporter answering a question that has been submitted for a
paragraph from an earnings call transcript, using a specific set of standards. Below is the
data:
[BEGIN DATA]
***
[Passage]: {passage}
***
[Query]: {query}
***
[Criterion]: Answer contained in the passage:
“1”: “No answer and not relevant - The query is entirely unrelated to the content of the
passage and contains no answer.”
“2”: “No answer but somewhat relevant - The query has weak relevance to the content of
the passage, the connection between them is unclear or incomplete, we cannot answer the
query based on the passage.”
“3”: “Partial answer and moderately relevant - The query is relevant to the content of the
answer passage and shows a clear connection, but there may be some gaps or minor
inconsistencies in relevance. If we want to answer the query accurately based on the
passage as context, the answer will be partial.”
“4”: “Explicit answer and perfectly relevant - The passage is perfectly and directly
relevant to the query, with a clear and complete connection between them. The answer is
not only relevant but also highly accurate, effectively and explicitly answering the query.”
***
[END DATA]
Judging by the criterion detailed above, is the query relevant to the passage? First, write out
in a step-by-step manner your reasoning about the criterion to be sure that your conclusion
is correct. Avoid simply stating the correct answers at the outset.
Then print the choice only from “1, 2, 3, 4” (without quotes or punctuation) on its own line
corresponding to the correct answer. At the end, repeat just the selected choice again by
itself on a new line.

One example benefit of this type of approach is that it can cast a “wider net” compared to searching for positive examples in a random selection of documents d (one at a time), making it more probable that any given candidate chunk of information c will be positive. This is because positive examples can be ranked highly by the baseline models. Moreover, the use of the scoring prompt can result in more precise relevance estimates since (i) the baseline models are applying both bi-encoding and cross-encoding to identify and rank the relevant chunks of information c and (ii) the LLM 1114 is asked to spell out its reasoning step-by-step. Moreover, in some cases, one or more positive examples and one or more negative examples may be identified from a common document d.

In some embodiments, the positive and negative examples identified here can be used to form triples having different forms for different models 1104, 1110. For example, because training a cross-encoding model may be of interest here, triples having the form (query, passage/chunk, score) may be used to train the cross-encoding model 1110, rather than triples having the form (query, more relevant document/chunk, less relevant document/chunk). Triples having the latter format can still be formed and used to train the bi-encoding model 1104, while triples having the former format can be formed and used to train the cross-encoding model 1110. In some cases, floating-point scores can be used as the training target with binary cross-entropy with logits loss during training of the cross-encoding model 1110, instead of triplet loss (which could be used during training of the bi-encoding model 1104). In particular embodiments, during training of the retriever model 112, K_{biencoder} may be set to a value of 1,000 or 1,500, and K_{cross_encoder} may be set to a value of 100 or 250.

The scoring that is performed using the at least one LLM 1114 helps to assess the relevance of the identified chunks of information c. In the example above, the scale ranges from one to four, with one indicating no relevance of a chunk of information c to a query q and four signifying high relevance of a chunk of information c to a query q. In some embodiments, given the cost factor associated with human evaluation, a Chain of Thought (CoT) evaluation technique may be used. For example, a CoT technique could establish a four-point or other scoring criterion and may employ a powerful language model (such as GPT4) to sequentially evaluate the relevance of each chunk of information c to its respective query q.

Triples (in both formats described above) can be used to train the bi-encoding model 1104 and the cross-encoding model 1110. In some cases, the bi-encoding model 1104 can be trained or fine-tuned as described above, such as with reference to FIG. 9, using triples with the format (query, more relevant document/chunk, less relevant document/chunk). Also, in some cases, the cross-encoding model 1110 can be trained or fine-tuned using triples with the format (query, passage/chunk, score). For instance, the cross-encoding model 1110 can be trained or fine-tuned on sentence pairs data using binary cross-entropy (BCE) with squared logits loss, which applies a sigmoid layer to the BCE loss and makes the BCE loss suitable for continuous labels between zero and one. In some cases, hyperparameters can be set to default values from sentence transformers, except for the number of training epochs (which can be selected to be large enough for different cross-encoding models 1110 to converge on an intrinsic evaluation). Example values that could be used during training of cross-encoding models 1110 are provided in the following table.

| Hyperparameter Name | Value |
|---|---|
| Batch size | 16 |
| Epochs | 20 |
| Warm up steps | 10% |
| Optimizer | Adam W |
| Loss Function | Binary cross entropy with logits loss |
| Learning rate | 2e−05 |
| Weight Decay | 0.01 |
| Maximum Gradient Normalization | 1 |

During training, an evaluator can evaluate model performance on held-out evaluation or testing data. In some cases, the evaluator can be used to determine the best cross-encoding model 1110 that has been trained and saved. Also, in some cases, the metric(s) used to select from among possible trained cross-encoding models 1110 may include the Pearson correlation and/or the Spearman correlation. Note, however, that this represents one example training technique and that other techniques may be used.

Note that, during the generation of training data using synthetic queries, it may be determined that there is little to no overlap of the original training dataset with the new training dataset, at least with respect to one or more desirable properties of the original training dataset. For example, the chunks of information c representing positive examples in the original training dataset may include only “hard examples,” which a conventional baseline model might have failed to rank highly in search results. By changing the positive example mining procedure to consider the top K results across the entire collection as positive example candidates, this could create a training dataset that has fewer “hard examples.” In some cases (including these cases), an extended training dataset can be created, such as by concatenating or appropriately sampling from both the original training dataset and the new training dataset. The size of the usable training dataset can also be further increased, such as by adding additional samples from a training dataset created previously and re-scoring the samples with the scoring approach described above. With updated scoring (such as a score out of four possible values), each sample receives a numerical score, which can be used during expansion of the training dataset.

Although FIGS. 12 and 13 illustrate examples of implementations of synthetic query and dataset generation, various changes may be made to FIGS. 12 and 13. For example, while each figure shows a series of steps, various steps in each figure may overlap, occur in parallel, occur in a different order, or occur any number of times.

Evaluation of Trained Retriever Model with Bi-Encoding and Cross-Encoding

After training a retriever model 112 having the form shown in FIG. 11 using generated training data (including training data associated with synthetic queries), the resulting trained retriever model 112 can be placed into use, such as when deployed to one or more other devices or otherwise placed into use. The following can be used to understand the effectiveness of the training based on the training data generated in this manner. As noted above, one of the many considerations within the evaluation is how to select appropriate evaluation data (such as approximately 1,000 query-ticker/company pairs) for evaluation from an entire set of potential pairs |Q|×|D|. There may be no way to know ahead of time if there will be an answer to a specific query q within a specific document d=d(t). The consequence of iterating during evaluation over too many (q, t) pairs without an answer is that it wastes computational time and budget on pairs from which no useful comparisons can be drawn.

In some cases, running an evaluation over a fixed set of tickers/companies and all queries q for those companies may show that a large percentage (such as up to roughly two-thirds or more) of the (q, t) pairs may not have any answer within d=d(t). A similar proportion of answer-less (q, t) could be expected if sampling over the query-ticker pairs is carried out uniformly randomly over Q×T. Thus, for example, of approximately 1,000 or other number of (q, t) pairs that an example computational budget might allow to be evaluated, roughly one-third or less may yield any significant information. It can therefore be useful to identify and implement a technique for sampling (q, t) that encourages the sampling of (q, t) pairs with answers to q in d(t).

One possible approach could be to use the results of positive example mining described above and count the number of distinct quarters (from among the various training quarters) for which each query-ticker pair (q, t) has at least one answer within the d(t), where d(t) is the ECT of ticker t in a training quarter. This statistic may be denoted as ans(q, t)_{training} or, for brevity when the quarters are clear from context, ans(q, t). Note that because there are three training quarters and one test quarter in the example described above, the statistic ans(q, t)_{training} may take one of the integer values in the range {0, 1, 2, 3}. A similar statistic may be denoted as ans(q, t)ₜₑₛₜ for the test quarter and may take one of the integer values in the range {0, 1}. Since ans(q, t)ₜₑₛₜ is unobserved, it can be predicted and thought of as a probability distribution. Taking a normalized version of ans(q, t)_{training}/3 as the best estimator of the mean of the probability distribution representing ans(q, t)ₜₑₛₜ could be viewed as providing a unnormalized probability distribution function (PDF) of a distribution over query-ticker pairs. During evaluation, (q, t) can be sampled according to a normalized version of this distribution.

While this could be done, there may be several drawbacks to using this approach in certain circumstances, such as data sparsity and censored observations. With respect to data sparsity, there may be too few datapoints per query-ticker pair (such as three in the training data at most) to validate or refute the predictive nature of the statistic strongly on the level of individual query-ticker pairs. With respect to censored observations, data that does exist tends to be noisy because there are an unknown number of query-ticker pairs in the training/test sets that do or do not have answers in the corresponding ECTs. In other words, the observed statistic ans(q, t) may always represent an underestimate of the true statistic ans(q, t).

As a basis for developing a more sophisticated approach described below, it is noted that the statistics ans(q, t) may not be independent. Rather, under a suitable notion of “similarity” for both queries q and tickers t, the metric ans(q, t) can be correlated for similar pairs (q, t). One possibility is to define the notion of similarity, such as by semantic similarity for queries and by grouping tickers into sector/market capitalization or other external factors. Another approach can be to look to the partially-observed data ans(q, t) as a guide for grouping (q, t). For instance, a specific approach to taking advantage of this could be to hypothesize a notion of similarity, such as semantic similarity for queries and sector/market capitalization for queries, and test the predictive power of a suitably-defined hierarchical model.

The following describes a novel approach that is more empirical and based on using the partially-observed data ans(q, t) alone as a basis for grouping (q, t). In this approach, the observed {ans(q, t)}{(q, t)∈Q×T} may be viewed as a matrix of interaction data between two distinct sets of homogeneous elements, such as queries q and tickers t in the example above. A larger entry in a row-column position corresponding to (q, t) would indicate more interaction between q and t than a smaller value. Based on this manner of viewing the data, bi-clustering can be used as a way of simultaneously grouping similar queries and tickers or other sets of homogeneous elements, in particular because of bi-clustering's sensitivity to similarity as measured on a subset of features (as opposed to similarity measured across all features simultaneously). This can be useful here because it can be imagined that, for example, t₁, t₂∈T and t₁˜t₂ (meaning they display similar patterns over time) based on certain queries q that relate to one aspect (such as debt of a business) but not based on other queries q that relate to other aspect(s) (such as management changes or earnings of the business). This type of situation lends itself well to the use of bi-clustering.

FIG. 14 illustrates an example implementation of a technique to evaluate the performance of a trained retriever model containing bi-encoding and cross-encoding models according to this disclosure. More specifically, FIG. 14 illustrates an example method 1400 for evaluating the performance of a retriever model 112 having the form shown in FIG. 11. For case of explanation, the method 1400 shown in FIG. 14 is described as being performed by the application server 106 in the system 100 shown in FIG. 1, where the application server 106 is implemented using one or more instances of the device 200 shown in FIG. 2. However, the method 1400 may be performed by any other suitable device(s) and in any other suitable system(s).

As shown in FIG. 14, one or more hyperparameters for bi-clustering are identified at step 1402. This may include, for example, the processing device 202 of the application server 106 automatically identifying or personnel manually identifying an estimated number of clusters to be used during bi-clustering and a minimum amount of data for each query q in order for that query q to be considered for clustering. Bi-clustering of datasets is performed to generate clusters of data at step 1404. This may include, for example, the processing device 202 of the application server 106 performing bi-clustering using the identified hyperparameter(s). In the context of queries related to ECTs for tickers (companies), for example, the bi-clustering may be used to cluster the queries and tickers independently. In some cases, the bi-clustering could be performed to cluster the queries and tickers or other contents of a training corpus and to cluster the queries and tickers or other contents for a testing or evaluation corpus. This results in the formation of multiple clusters of data.

One or more metrics are determined for the clusters of data at step 1406. This may include, for example, the processing device 202 of the application server 106 determining one or more metrics indicative of the similarity of different clusters of data. Example types of metrics may include an adjusted Rand index metric and/or an adjusted mutual information metric. The metrics for each dataset (such as for queries and for tickers) can be averaged over each dataset in order to generate the final metric value(s) for each dataset. A probability distribution is determined based on the metric(s) at step 1408. This may include, for example, the processing device 202 of the application server 106 determining an unnormalized probability distribution associated with the bi-clustering results based on the calculated metric values. This may also include the processing device 202 of the application server 106 determining a normalized probability distribution based on the unnormalized probability distribution.

Data is sampled during an evaluation of a trained retriever model based on the determined probability distribution at step 1410. This may include, for example, the processing device 202 of the application server 106 sampling data from a testing corpus based on the normalized probability distribution. In the context of queries related to ECTs for tickers, for example, this may include the processing device 202 of the application server 106 selecting query-ticker pairs in which it is more likely that an answer to the query can be generated.

Specific embodiments of the method 1400 may be implemented in the following manner. As noted above, in some cases, there may be two hyperparameters that can be tuned in the bi-clustering. The first hyperparameter may be n:=n_clusters, meaning the number of clusters of both the tickers and queries or other datasets, leading to a total of n² bi-clusters of pairs (q, t). The origin of the second hyperparameter is an observation that there are significant number of queries q∈Q_{ECT}⁺ for which Σ_{t∈T} ans(q, t) is small (meaning all entries of the row of the data matrix corresponding to each of those queries q are small). Such queries q provide little or no useful information to the bi-clustering and can be excluded. There may be no obvious value for a minimum amount of data-per-query that could be calculated ahead of time. The second hyperparameter m may therefore be referred to as a “data-per-query threshold,” and queries q not rising to that threshold can be excluded. In some cases, the use of the second hyperparameter m may be expressed as follows.

$$q ∈ {Q}_{ECT}^{+} such that \sum t ∈ T ans ( q , t ) \leq m \qquad ( 30 )$$

In some embodiments, one way of tuning such hyperparameters is via cross-validation. One idea behind cross-validation is to test the predictive power of a model “out of training sample,” and a related technique of testing the predictive power of the model “out of training sample” can be adopted. For instance, data can be divided just once (rather than several times) into the data derived from the training quarter(s) {ans(q, t)}_{training} and the data derived from the test quarter(s) alone {ans(q, t)}ₜₑₛₜ. Note that because of the way interaction matrices are defined, the following matrix identity can also be defined.

$${\{ ans ( q , t ) \}}_{training} + {\{ ans ( q , t ) \}}_{test} = \{ ans ( q , t ) \} \qquad ( 31 )$$

For a fixed choice of hyperparameters (n, m), bi-clustering can be performed using {ans(q, t)}_{training} and for {ans(q, t)}ₜₑₛₜ independently. A bi-clustering induces two clusterings (partitions) of the set Q and of the set T. One or more metrics for comparing the partitions of the sets can be calculated, such as an adjusted Rand index metric and an adjusted mutual information metric, and these metrics can be averaged over Q and T. In some cases, the hyperparameters (n, m) can be selected so as to maximize the values of these metrics. Assume, for example, that both metrics are maximized (or achieve close to the maximum) at n=8 and m=3. In that case, an unnormalized probability distribution can be based on the bi-clustering of {ans(q, t)}{(q, t)∈Q×T} under these hyperparameter settings.

This technique can be formalized in the following manner. Let the bi-clustering be fixed, let [symbol] (q) denote the cluster to which q∈Q is assigned by the bi-clustering, and let [symbol] (t) denote the cluster to which t∈T is assigned. Given that, the following expression can be defined.

$$( q , t ) := ( ans ( {q}^{′} , {t}^{′} ) ) / ( \vert ( t ) \vert \times \vert ( q ) \vert ) \qquad ( 32 )$$

In other words, the unnormalized probability assigned to q, t is the mean interaction statistic over the bi-cluster containing (q, t). A normalized probability distribution from which sampling in the evaluation can be performed may represent a normalized version P(q, t):= [symbol] (q, t)/Z, where Z denotes a partition function. In some cases, the partition function may be defined as follows.

$$Z := {\sum }_{q , t ∈ Q \times T} ( q , t ) \qquad ( 33 )$$

In some embodiments, the result of using this sampling technique can significantly increase the proportion of query-ticker pairs examined, in the course of the evaluation, which have an answer (possibly doubling the proportion of query-ticker pairs or increasing it even more).

In some embodiments, an evaluation of different fine-tuned cross-encoding models 1110 (such as to select one for deployment or other use) may include two components or evaluations, namely an intrinsic evaluation and an extrinsic evaluation. For example, an intrinsic evaluation may include comparing outputs of each cross-encoding model 1110 with provided ground-truths on semantic similarity. This evaluation can be simpler, less expensive to compute, and independent of downstream tasks. However, relying solely on intrinsic evaluations can be misleading in some circumstances. For instance, the cross-encoding models 1110 are not meant to be used for measuring the similarity of two texts in isolation but rather are meant to be used for finding most similar chunks of information e given a search query q. For this reason, it can be more relevant that the cross-encoding models 1110 are able to identify the relatively few chunks of information c with high similarity, rather than scoring accurately dissimilar chunks. In the case of intrinsic metrics, all calculated scores might contribute equally to the result. Because of this, intrinsic evaluation results may not translate accurately to performance in an intended task. Despite the downsides, a strong result in an intrinsic evaluation is still a good indicator of strong performance in sentence similarity-based tasks while being computationally cheap, which makes it a good metric to guide development. Once developed, final fine-tuned cross-encoding models 1110 may go through an extrinsic evaluation pipeline.

During extrinsic evaluation, pairwise comparisons may be performed to compare the results from different cross-encoding models 1110 obtained using the retrieval evaluation framework. For example, the extrinsic evaluation may compare the results from different cross-encoding models 1110 in order to determine which cross-encoding model 1110 performs better in different scenarios.

Using these techniques, it is possible to create new relevance/ranking datasets that address some drawbacks of other approaches and that can be harnessed to fine-tuning both cross-encoding models 1110 and bi-encoding models 1104. For example, without any notable increase in the amount of human labeling and curation required, it can be possible to expand the number of queries q present and largely correct data imbalances across queries q.

Note that other or additional approaches for training/evaluating a bi-encoding model 1104 may be used here. Also, in some cases, it may be possible for a cross-encoding model 1110 alone to perform retrieval at scale, without the use of a bi-encoding model 1104 to provide an initial pruning. Once final versions of a dataset and a cross-encoding model 1110 are obtained, it is possible to experiment with the techniques described above (or variants thereof) to determine if a simpler one-step retrieval system using just a cross-encoding model 1110 without a bi-encoding model 1104 can obtain comparable or better retrieval results on the same or smaller computational budget.

Although FIG. 14 illustrates one example of an implementation of a technique to evaluate the performance of a trained retriever model 112 containing bi-encoding and cross-encoding models 1104, 1110, various changes may be made to FIG. 14. For example, while shown as a series of steps, various steps in FIG. 14 may overlap, occur in parallel, occur in a different order, or occur any number of times.

Example Processes for Retriever Models with Bi-Encoding and Cross-Encoding

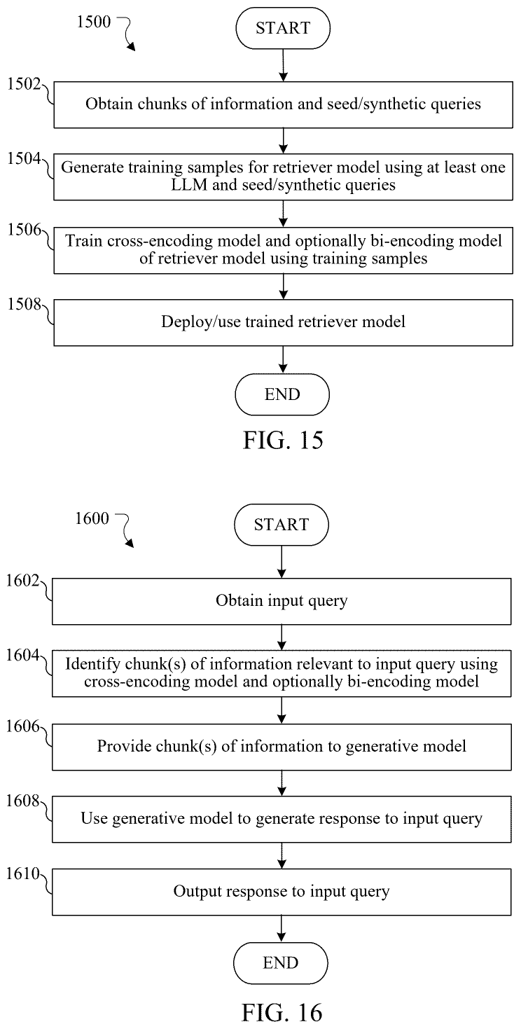

FIG. 15 illustrates an example method 1500 for data generation and retraining techniques for fine-tuning of retriever models containing bi-encoding and cross-encoding models according to this disclosure. For case of explanation, the method 1500 shown in FIG. 15 is described as being performed by the application server 106 in the system 100 shown in FIG. 1, where the application server 106 is implemented using one or more instances of the device 200 shown in FIG. 2. However, the method 1500 may be performed by any other suitable device(s) and in any other suitable system(s).

As shown in FIG. 15, chunks of information and seed/synthetic queries are obtained at step 1502. This may include, for example, the processing device 202 of the application server 106 obtaining chunks of information c from various documents d or other source(s). This may also include the processing device 202 of the application server 106 obtaining a set of queries Q_{ECT} from one or more subject matter experts or other users or from other source(s). This may further include the processing device 202 of the application server 106 generating synthetic queries based on the queries q in the set Q_{ECT}, such as by using the method 1200. Thus, for instance, prompts may be generated and provided to one or more LLMs 1114 and may contain sampled queries from the set Q_{ECT}, and the one or more LLMs 1114 may generate synthetic queries in response to the prompts. Any suitable number of chunks of information c and any suitable number of queries q in the set Q_{ECT} may be obtained here, and any suitable number of synthetic queries may be generated to produce an updated set Q_{ECT}⁺.

As described above, one example technique for generating synthetic queries can include converting example queries q from the set Q_{ECT} into dense vector representations and clustering the dense vector representations into multiple clusters. A subset of the clusters may be randomly selected, and an example query q can be randomly selected from each of the selected clusters. A prompt template can be used to create a prompt based on the selected example queries q, and the prompt can be used (such as by one or more LLMs 1114) to generate one or more synthetic queries q. This can be repeated any number of times to obtain the desired number of synthetic queries or the desired size of the updated set Q_{ECT}+.

Training samples for a retriever model are generated using at least one LLM based on the chunks of information and the seed and synthetic queries at step 1504. This may include, for example, the processing device 202 of the application server 106 using the method 1300 to generate positive examples and using the method 500 or other technique(s) described above to generate negative examples. As noted above, in some cases, a first subset of the training samples can include triples having the form (query, more relevant document/chunk, less relevant document/chunk), and a second subset of the training samples can include triples having the form (query, passage/chunk, score). Also, in some cases, a bi-encoding/cross-encoding pipeline (such as one with a baseline bi-encoding model 1104 and a baseline cross-encoding model 1110) may be used to identify chunks of information c that might or might not be relevant to the queries q in the set Q_{ECT}⁺, and one or more LLMs 1114 may be used to determine a degree of relevance of each of those chunks of information c to its corresponding query q.

In some embodiments, the training samples may be generated by using a baseline bi-encoding model 1104 to identify chunks of information c that might be or might not be relevant to the queries in the set Q_{ECT}⁺ (and a baseline cross-encoding model 1110 might optionally be used to re-rank the identified chunks of information c), and at least one LLM 1114 can be used to determine whether each identified chunk of information c actually is or is not relevant to the corresponding query q. In some cases, the LLM(s) 1114 may use scoring, such as by generating scores between one and four as described above, to identify the degree of relevance of each identified chunk of information c to its corresponding query q. In other embodiments, the baseline bi-encoding model 1104 may be used to identify both positive and negative training examples. In still other embodiments, the baseline bi-encoding model 1104 may be used to identify positive training examples, and one or more other techniques may be used to identify negative training examples. In particular embodiments, multiple LLMs 1114 may be used, such as when (i) a first LLM 1114 is prompted with multiple pairs of chunks of information c and asked to identify which chunk in each pair is more or less relevant to a corresponding query q and (ii) a second LLM 1114 is prompted using the chunks of information c identified by the first LLM 1114 and asked to generate training samples based on those chunks.

A cross-encoding model and optionally a bi-encoding model of the retriever model are trained using the training samples at step 1506. This may include, for example, the processing device 202 of the application server 106 using the training samples with triples having the form (query, passage/chunk, score) to train the cross-encoding model 1110. If the bi-encoding model 1104 is used, this may also include the processing device 202 of the application server 106 using the training samples with triples having the form (query, more relevant document/chunk, less relevant document/chunk) to train the bi-encoding model 1104. There are various techniques known for training each of these types of machine learning models, and additional techniques are sure to be developed in the future. Any suitable technique or techniques may be used here, and this disclosure is not limited to any specific training technique. The training may optionally include using an evaluation technique (such as the one described above) to determine how well the trained retriever model 112 appears to operate. In some cases, the evaluation may use bi-clustering, such as by using the method 1400.

In some embodiments, both the bi-encoding model 1104 and the cross-encoding model 1110 may be used in the retriever model 112, and both can be trained as part of step 1506. For example, the bi-encoding model 1104 may be trained to perform initial embedding-based retrieval of chunks of information c from a corpus, and the cross-encoding model 1110 may be trained to perform re-ranking or refinement of the retrieved chunks of information c identified by the bi-encoding model 1104. Also, in some embodiments, one or more evaluation metrics may be determined and used as part of an evaluation of the retriever model 112 as trained. For instance, the one or more evaluation metrics may include an adjusted Rand index metric and/or an adjusted mutual information metric. The one or more evaluation metrics could be used, for instance, to compare the trained retriever model 112 and an untrained retrieval pipeline.

The trained retriever model can be deployed or placed into use, such as for inferencing, at step 1508. This may include, for example, the processing device 202 of the application server 106 providing the trained retriever model 112 for use by the application server 106 or one or more other devices.

Although FIG. 15 illustrates one example of a method 1500 for data generation and retraining techniques for fine-tuning of retriever models containing bi-encoding and cross-encoding models, various changes may be made to FIG. 15. For instance, while shown as a series of steps, various steps in FIG. 15 may overlap, occur in parallel, occur in a different order, or occur any number of times. Also, at least some of the steps in the method 1500 may be performed any number of times to train any number of retriever models.

FIG. 16 illustrates an example method 1600 for using fine-tuned retriever models containing bi-encoding and cross-encoding models according to this disclosure. For case of explanation, the method 1600 shown in FIG. 16 is described as being performed by the application server 106 in the system 100 shown in FIG. 1, where the application server 106 is implemented using one or more instances of the device 200 shown in FIG. 2. However, the method 1600 may be performed by any other suitable device(s) and in any other suitable system(s).

As shown in FIG. 16, an input query is obtained at step 1602. This may include, for example, the processing device 202 of the application server 106 obtaining a user query from a user of a user device 102a-102d or other input query. The input query may have any suitable form, such as a natural language query. One or more chunks of information relevant to the input query are identified at step 1604. This may include, for example, the processing device 202 of the application server 106 using a retriever model 112 having the form shown in FIG. 11 (which may be trained in accordance with the method 1500 of FIG. 15) to identify one or more chunks of information relevant to the input query.

The one or more chunks of information are provided to a generative model at step 1606. This may include, for example, the processing device 202 of the application server 106 generating a prompt that includes or is based on the input query and the identified chunk(s) of information. The generative model is used to generate a response to the input query at step 1608. This may include, for example, the processing device 202 of the application server 106 providing the prompt to the generative model 114. This may also include the generative model 114 using the identified chunk(s) of information in the prompt as context when generating the response to the input query. The response to the input query is output at step 1610. This may include, for example, the processing device 202 of the application server 106 providing the response to the user device 102a-102d for presentation to at least one user.

Although FIG. 16 illustrates one example of a method 1600 for using fine-tuned retriever models containing bi-encoding and cross-encoding models, various changes may be made to FIG. 16. For instance, while shown as a series of steps, various steps in FIG. 16 may overlap, occur in parallel, occur in a different order, or occur any number of times.

The following provides a specific example of a process for training a retriever model 112 having the form shown in FIG. 11. Some out-of-the-box generic retrieval or re-ranking models can perform poorly on certain types of data (such as financial text data), and realistic high-quality full-scale Q&A datasets can be hard to obtain for use during training. Since annotated “gold” Q&A or relevance data may be difficult to obtain but unlabeled documents (such as research reports, earnings call transcripts, and filings) are plentiful, it is possible to train in-domain relevance ranking/retrieval using open-source LLMs and large unlabeled corpora to provide some form of weak supervision/data augmentation. The following describes an example approach for performing this type of training. Moreover, approaches to this problem for general Q&A datasets can often underperform using smaller datasets (such as financial datasets). Several possible enhancements are described below, and it can be determined (such as via ablation studies) which of these enhancements have the highest impact in a realistic scenario (if any).

Note that specific Q&A datasets are used in the following discussion but are examples only. For example, one dataset used below is called a “large” dataset and could have more (such as ˜1e5) documents. Another dataset used below is called a “small” dataset and could have less (such as ˜1e3) documents. Each dataset could support around 30 queries per document. The large dataset may be “weakly” labeled, such as by using one or more fine-tuned models, and can be used for retriever model training purposes. The small dataset may be generated using at least one LLM 1114, can be validated by one or more humans, and can be used for retriever model testing purposes. A third dataset may have the same or similar size as the small dataset and may be used for retriever model validation purposes, such as determining at least one stopping criterion during an iterative training process described below. In the context of a financial use case, for instance, these datasets may be generated by dividing a public corpus that includes Securities and Exchange Commission (SEC) filings, earnings call transcripts, research reports, etc. In some cases, the dates of the training documents may be earlier than the dates of the validation documents, and the dates of the validation documents may be earlier than the dates of the testing documents.

In the example process described below, one or more LLMs 1114 may be used as part of the generation of training data and/or as part of an evaluation process. In some cases, an LLM stack can include a “strong” LLM and optionally a “weak” LLM and a “commercial” LLM. The “strong” LLM may represent a large open-source model, such as one in which fine-tuning and other operations may be performed. In some cases, the fine-tuning may be performed using Parameter-Efficient Fine-Tuning (PEFT) Low-Rank Adaptation (LoRA). The “weak” LLM may optionally be used for comparisons in some cases. The “commercial” LLM may optionally be used for final evaluation purposes in some cases. Because of their longer context windows, commercial LLMs can often be used either without retriever-augmented generation (RAG) on an entire document or with a much longer list of chunks. In some cases, none of the inventive datasets or models may be trained on signals from commercial LLMs.

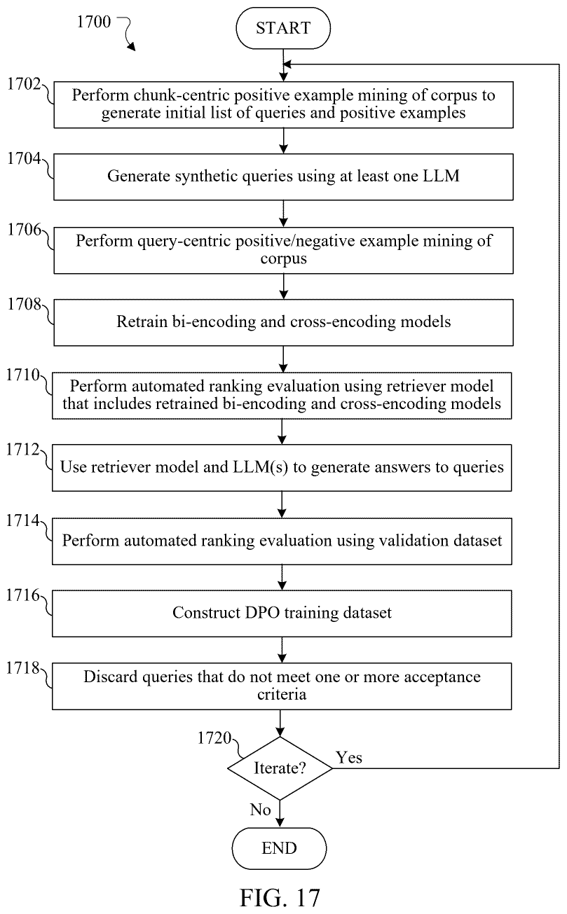

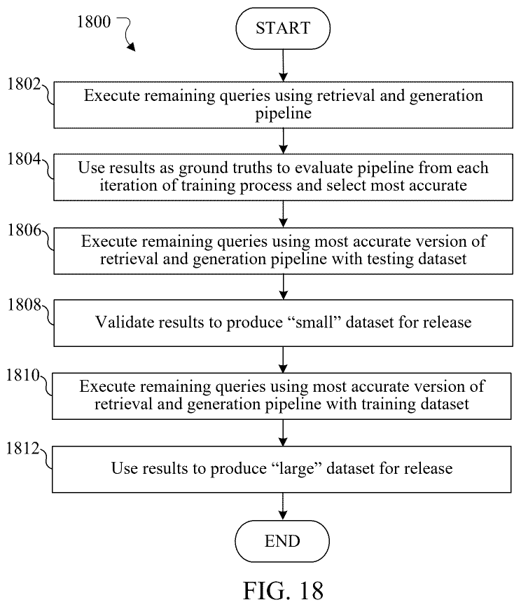

FIGS. 17 and 18 illustrate a specific example of methods 1700, 1800 for fine-tuning of retriever models containing bi-encoding and cross-encoding models according to this disclosure. For case of explanation, the methods 1700, 1800 shown in FIGS. 17 and 18 are described as being performed by the application server 106 in the system 100 shown in FIG. 1, where the application server 106 is implemented using one or more instances of the device 200 shown in FIG. 2. However, the methods 1700, 1800 may be performed by any other suitable device(s) and in any other suitable system(s). An iteration of the process shown in FIG. 17 may be identified using i.

As shown in FIG. 17, chunk-centric positive example mining of a corpus is performed to generate an initial list of queries and positive examples at step 1702. This may include, for example, the processing device 202 of the application server 106 obtaining an unlabeled and chunked corpus, where the chunks of information may have a common size or variable sizes. In some cases, the chunk-centric positive example mining may be performed using one or more LLMs 1114, such as one or more LLMs 1114 having a temperature greater than zero (temperature controls the randomness and therefore the creativity of an LLM, such as when higher values indicate more randomness). The chunk-centric positive example mining may occur in any suitable manner, such as by using the techniques disclosed above or the techniques disclosed in Bonifacio et al., “Inpars: Unsupervised dataset generation for information retrieval,” Proceedings of the 45th International ACM SIGIR Conference on Research and Development in Information Retrieval, July 2022, pages 2387-2392 (which is hereby incorporated by reference in its entirety).

Synthetic queries are generated using at least one LLM at step 1704. This may include, for example, the processing device 202 of the application server 106 providing prompts to one or more LLMs 1114 asking the LLM(s) 1114 to produce synthetic queries. The synthetic queries can be generated based on the initial list of queries produced in step 1702 and optionally based on queries produced during one or more prior iterations (if any) of the process in FIG. 17. In some embodiments, a “few-shot” prompt (such as one described above or one from an ml-labs repo) may be used. The LLM(s) 1114 used here may have a temperature greater than zero.

Query-centric positive/negative example mining of the corpus is performed at step 1706. This may include, for example, the processing device 202 of the application server 106 using one or more techniques described above to generate positive and negative examples involving the corpus for each query. In some cases, at least one LLM 1114 may be used to evaluate a limited number of chunks of information c from the corpus. For example, the corpus may include on the order of ˜1e7 chunks of information c, and the LLM(s) 1114 here could evaluate between about ˜1e2 and about ˜5e2 of the top chunks of information c.

Bi-encoding and cross-encoding models are retrained at step 1708. This may include, for example, the processing device 202 of the application server 106 retraining an original version of the bi-encoding model 1104 and an original version of the cross-encoding model 1110 during the first iteration of the process in FIG. 17. This may also include the processing device 202 of the application server 106 retraining a previous version of the bi-encoding model 1104 and a previous version of the cross-encoding model 1110 as produced during the previous iteration of the process in FIG. 17. This retrained can be based on the dataset of positive and negative examples formed in the preceding step, as well as data obtained during one or more prior iterations (if any). This results in the creation of new versions of the bi-encoding and cross-encoding models 1104, 1110.

Automated ranking evaluation is performed using a retriever model that includes the retrained bi-encoding and cross-encoding models at step 1710. This may include, for example, the processing device 202 of the application server 106 using a collection of query/document pairs (such as on the order of ˜1e4 query/document pairs). In some cases, documents d for each query q may be selected, such as by randomly sampling from documents where at least one chunk of information c appears in the top results (such as within the top ˜5e2 results) for the query q. In some embodiments, this evaluation can be performed using a baseline retriever model, the prior (i^{th}) version of the retrieval pipeline, and an experimental/retrained (i+1)^{th} version of the retrieval pipeline. At least one LLM 1114 may be used as a judge to select which model provides better results in response to various queries q. In some cases, this may lead to a set of weakly-labeled query/chunk pairs (such as on the order of ˜1e5 pairs), which could be saved in a “granular results” file. The “granular results” file may be mined into additional training triples for the bi-encoding and cross-encoding models to be used in step 1708 during the next iteration of the process (if one occurs). In particular embodiments, this may be done using a criterion that (query, positive example p, negative example n) (along with (query q, positive example p, score) and (query q, negative example n, score) for the cross-encoding model) is appended to the dataset if Rank (i+1, p)>Rank (i+1,n) and p is judged more relevant than n.

The retriever model and one or more LLMs are used to generate answers to queries at step 1712. This may include, for example, the processing device 202 of the application server 106 using the granular results file from step 1710 and one or more LLMs 1114 to generate RAG answers, such as answers to the approximately ˜1e4 query/document pairs. The answers generated here may be used in steps 1716 and 1718 below. In some cases, step 1712 can be performed in parallel with step 1710.

Automated ranking evaluation is performed using a validation dataset at step 1714. This may include, for example, the processing device 202 of the application server 106 performing an automated ranking evaluation on a validation dataset, such as for about ˜1e3 query/document pairs, using the commercial LLM. If at least one iteration has been performed, this evaluation may also include evaluating at least one stopping criterion, such as by determining if there has been no significant improvement observed over a previous iteration. In some cases, step 1714 can be performed in parallel with step 1710 and/or step 1712.

A DPO training dataset is constructed at step 1716. This may include, for example, the processing device 202 of the application server 106 constructing a DPO training dataset from the results of steps 1710 and 1712. In some cases, this may be performed using the following heuristic. If (d₁, . . . , dₖ) are the chunks retrieved and judged in the “granular results” file for a query q and a fixed document d, a prompt having the format “Form a passage relevant to the following query: {q}” can be generated. Documents can be ordered by score to produce a preference dataset, and DPO and this preference dataset may be used to train the next version of an LLM 1114. Queries that do not meet one or more acceptance criteria are discarded at step 1718. This may include, for example, the processing device 202 of the application server 106 discarding queries q having no or too few answers found in the corpus (such as less than a threshold number).

If at least one stopping criterion has not yet been met, a determination can be made to iterate the process at step 1720, at which point the process can return to step 1702. Each iteration of the process can result in the creation of a unique version of a retriever model 112 associated with a unique bi-encoding model 1104, a unique cross-encoding model 1110, and a unique LLM 1114. Each version can be stored for subsequent analysis and use. Thus, for instance, assuming the at least one stopping criterion is met after n+1 iterations, this can result in the generation of retriever models 112 with versions 0 through n (any one of which could represent the “best” model). These models can be analyzed during the process shown in FIG. 18.

As shown in FIG. 18, remaining queries are executed using a retrieval and generation pipeline at step 1802. This may include, for example, the processing device 202 of the application server 106 processing any queries q not used during the process shown in FIG. 17 using a pipeline that includes a trained bi-encoding model 1104, a trained cross-encoding model 1110, and a commercial LLM 1114 or other generative model 114. In some cases, the trained bi-encoding model 1104 and the trained cross-encoding model 1110 may represent the last versions of the models produced during the method 1700 (such as the n^{th} version of the bi-encoding model 1104 and the n′h version of the trained cross-encoding model 1110). This step may be performed using at least one criterion to select query-document pairs from all possibilities (meaning the entire corpus), such as for each query q. As a particular example, this may include selecting the N highest-ranking chunks of information c from the testing dataset.

The results are used as ground truths for the testing dataset in order to evaluate the pipeline from each iteration of the training process at step 1804. This may include, for example, the processing device 202 of the application server 106 using the ground truths to retrospectively evaluate the accuracy of each pipeline that includes the i^{th} trained bi-encoding model 1104, the i^{th} trained cross-encoding model 1110, and the i^{th} LLM 1114 produced during the n+1 iterations, where i=0, . . . , n. The same query-document pairs used in step 1802 may be used here. It can also be determined here which iteration produced the pipeline having the highest accuracy. Assume that the maximum accuracy is achieved at iteration i=m, which may or may not be less than n.

The remaining queries are executed using the most accurate (m^{th}) version of the retrieval and generation pipeline using the testing dataset at step 1806. This may include, for example, the processing device 202 of the application server 106 executing queries q using a pipeline that includes the m^{th} trained bi-encoding model 1104, the m^{th} trained cross-encoding model 1110, and the m^{th} LLM 1114 produced during the m^{th} training iteration. In some cases, the testing dataset can be used in conjunction with selected queries q. The results are validated to produce a “small” dataset for release at step 1808. This may include, for example, the processing device 202 of the application server 106 validating all or a selection of the results from step 1806, such as based on confidence numbers/complexities or other criteria. This can be done to produce a high-quality “small” dataset, which may be releasable (such as to external entities).

The remaining queries are executed using the most accurate (m^{th}) version of the retrieval and generation pipeline using the training dataset at step 1810. This may include, for example, the processing device 202 of the application server 106 executing queries q using the pipeline that includes the m^{th} trained bi-encoding model 1104, the m^{th} trained cross-encoding model 1110, and the m^{th} LLM 1114 produced during the m^{th} training iteration. In some cases, the training dataset can be prioritized using one or more criteria for each query q, such as by prioritizing documents d having at least one chunk of information c in the top ˜1e3 or other number of chunks for that query q. The results are validated to produce a “large” dataset for release at step 1812. This may include, for example, the processing device 202 of the application server 106 validating all or a selection of the results from step 1810 to produce a soft-labeled “large” dataset, which may be releasable (such as to external entities).

In some embodiments, one or more enhancements to the retriever model 112 or the process of training the retriever model 112 may be used. In order to determine which specific enhancement or enhancements (if any) might be useful in any given implementation, the following process may be performed. First, a baseline retriever model can be obtained, such as one that is based on or similar to an InPars or Promptagator model. In some cases, the baseline retriever model may rely on queries that are generated based on chunks of information (such as in the manner described above), and the same chunks of information can be used when retraining a retrieval pipeline. Using the baseline model, it is possible to test which of various enhancements may improve performance of the baseline model. One enhancement could be iteratively generating queries using at least one LLM and few-shot prompting. Another enhancement could be mining for examples from across a corpus using positive/negative example mining strategies (such as those exploited to create GTE or other models or those described above). Yet another enhancement could be feeding examples identified in the automated ranking evaluation process, applied on individual documents sampled from a training corpus, back into a training pipeline. Still another enhancement could be using direct preference optimization (DPO) to retrain a strong LLM used for judging results, producing a checkpoint of the strong LLM that can be used in subsequent iterations of the process. By using various individual enhancements or combinations of enhancements, it is possible to perform error analysis, ablation studies, or other analyses to identify which strategies work, to what extent, and why. An individual enhancement or combination of enhancements may be selected and used in the training process above. Note, however, that other approaches may be used here, such as using individual enhancements or combinations of enhancements in different occurrences of the training process above and determining which resulting trained retriever model 112 performs best.

Although FIGS. 17 and 18 illustrate one specific example of methods 1700, 1800 for fine-tuning of retriever models containing bi-encoding and cross-encoding models, various changes may be made to FIGS. 17 and 18. For example, while each figure shows a series of steps, various steps in each figure may overlap, occur in parallel, occur in a different order, or occur any number of times.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A method comprising:
obtaining (i) a corpus comprising chunks of information and (ii) a plurality of seed queries;
training a retrieval pipeline comprising a bi-encoding model and a cross-encoding model using the corpus and the plurality of seed queries; and
outputting a trained bi-encoding model and a trained cross-encoding model;
wherein training the retrieval pipeline comprises:
training the bi-encoding model to perform initial embedding-based retrieval of subsets of the chunks of information from the corpus; and
training the cross-encoding model to re-rank at least some of the retrieved chunks of information in the subsets.

2. The method of claim 1, wherein training the retrieval pipeline further comprises:
identifying and outputting one or more evaluation metrics comparing the trained retrieval pipeline and an untrained retrieval pipeline.

3. The method of claim 1, wherein training the retrieval pipeline further comprises:
providing the plurality of seed queries to at least one large language model; and
receiving additional queries from the at least one large language model.

4. The method of claim 1, further comprising:
obtaining an input query at a retriever model, the retriever model including the trained bi-encoding model and the trained cross-encoding model, the retriever model configured to identify specified chunks of information relevant to the input query;
providing one or more of the specified chunks of information from the retriever model to a generative model; and
using the generative model to create a response to the input query, the response based on the one or more specified chunks of information.

5. The method of claim 1, further comprising:
using the corpus and the plurality of seed queries to generate positive and negative training examples for the bi-encoding model and the cross-encoding model;
wherein the positive and negative training examples for the bi-encoding model include triples having a form (query, more relevant document/chunk, less relevant document/chunk); and
wherein the positive and negative training examples for the cross-encoding model include triples having a form (query, passage/chunk, score).

6. The method of claim 1, further comprising:
performing an evaluation of the trained bi-encoding model and the trained cross-encoding model;
wherein the evaluation comprises:
performing bi-clustering to generate clusters of data related to the corpus;
determining a probability distribution based on one or more metrics associated with the clusters; and
sampling data from a testing corpus based on the probability distribution.

7.-20. (canceled)

21. The method of claim 3, wherein the additional queries are generated by:
converting the plurality of seed queries into dense vector representations;
clustering the dense vector representations into multiple clusters;
randomly selecting a subset of the clusters;
randomly selecting an example query from each of the selected subset of the clusters;
using a template to create a prompt from the selected example queries; and
providing the prompt to the at least one large language model to generate one or more additional queries.

22. The method of claim 1, wherein training the retrieval pipeline comprises:
identifying subsets of the chunks of information that might be or might not be relevant to the seed queries; and
using at least one large language model to determine whether the subsets of the chunks of information actually are or are not relevant to the seed queries.

23. The method of claim 22, wherein:
identifying the subsets of the chunks of information that might be or might not be relevant to the seed queries comprises identifying positive and negative training examples;
the positive training examples represent chunks of information that might be relevant to the seed queries; and
the negative training examples represent chunks of information that might not be relevant to the seed queries.

24. The method of claim 23, wherein:
the at least one large language model ranks the positive training examples and the negative training examples, the at least one large language model ranking the positive training examples as being more relevant to the seed queries and ranking the negative training examples as being less relevant or irrelevant to the seed queries; and
the cross-encoding model and the bi-encoding model rank the positive training examples and the negative training examples, the cross-encoding model and the bi-encoding model ranking the negative training examples higher than the positive training examples.

25. The method of claim 23, wherein using the at least one large language model to determine whether the subsets of the chunks of information actually are or are not relevant to the seed queries comprises:
using the at least one large language model to judge the positive and negative training examples and determine which of the positive and negative training examples to use.

26. The method of claim 25, wherein:
a first large language model processes pairs of chunks of information to determine which of the chunks of information is more or less relevant to the seed queries; and
a second large language model processes candidate chunks of information selected by the first large language model to generate training samples.

27. An apparatus comprising:
at least one processing device configured to:
train a retrieval pipeline comprising a bi-encoding model and a cross-encoding model using (i) a corpus comprising chunks of information and (ii) a plurality of seed queries; and
output a trained bi-encoding model and a trained cross-encoding model;
wherein, to train the retrieval pipeline, the at least one processing device is configured to:
train the bi-encoding model to perform initial embedding-based retrieval of a subset of chunks of information from the corpus; and
train the cross-encoding model to re-rank at least some of the retrieved chunks of information in the subset.

28. The apparatus of claim 27, wherein:
the at least one processing device is further configured to use the corpus and the plurality of seed queries to generate positive and negative training examples for the bi-encoding model and the cross-encoding model;
the positive and negative training examples for the bi-encoding model include triples having a form (query, more relevant document/chunk, less relevant document/chunk); and
the positive and negative training examples for the cross-encoding model include triples having a form (query, passage/chunk, score).

29. The apparatus of claim 27, wherein:
the at least one processing device is further configured to perform an evaluation of the trained bi-encoding model and the trained cross-encoding model; and
to perform the evaluation, the at least one processing device is configured to:
perform bi-clustering to generate clusters of data related to the corpus;
determine a probability distribution based on one or more metrics associated with the clusters; and
sample data from a testing corpus based on the probability distribution.

30. The apparatus of claim 27, wherein, to train the retrieval pipeline, the at least one processing device is further configured to:
provide the plurality of seed queries to at least one large language model; and
receive additional queries from the at least one large language model.

31. The apparatus of claim 30, wherein the at least one processing device is further configured to:
convert the plurality of seed queries into dense vector representations;
cluster the dense vector representations into multiple clusters;
randomly select a subset of the clusters;
randomly select an example query from each of the selected subset of the clusters;
use a template to create a prompt from the selected example queries; and
provide the prompt to the at least one large language model to generate one or more additional queries.

32. The apparatus of claim 27, wherein:
to train the retrieval pipeline, the at least one processing device is configured to:
identify subsets of the chunks of information that might be or might not be relevant to the seed queries; and
use at least one large language model to identify positive and negative training examples;
the positive training examples represent chunks of information that might be relevant to the seed queries; and
the negative training examples represent chunks of information that might not be relevant to the seed queries.

33. The apparatus of claim 32, wherein, to use the at least one large language model to determine whether the subsets of the chunks of information actually are or are not relevant to the seed queries, the at least one processing device is configured to:
use the at least one large language model to judge the positive and negative training examples and determine which of the positive and negative training examples to use.

34. A non-transitory computer readable medium containing instructions that when executed cause at least one processor to:
train a retrieval pipeline comprising a bi-encoding model and a cross-encoding model using (i) a corpus comprising chunks of information and (ii) a plurality of seed queries; and
output a trained bi-encoding model and a trained cross-encoding model;
wherein the instructions that when executed cause the at least one processor to train the retrieval pipeline comprise instructions that when executed cause the at least one processor to:
train the bi-encoding model to perform initial embedding-based retrieval of a subset of chunks of information from the corpus; and
train the cross-encoding model to re-rank at least some of the retrieved chunks of information in the subset.
